(19) United States
(12) Patent Application Publication
(10) Pub. No.: US 2012/0041685 A1
(43) Pub. Date: Feb. 16, 2012

(54) SYSTEM AND METHOD FOR ESTIMATING RADIATION DOSE AND DISTRIBUTION USING MEDIUM-DEPENDENT-CORRECTION BASED ALGORITHMS (MDC)

(75) Inventors: George Ding, Nashville, TN (US); Jason Pawlowski, Nashville, TN (US)

(73) Assignee: Vanderbilt University, Nashville, TN (US)

(21) Appl. No.: 13/181,908

(22) Filed: Jul. 13, 2011

Related U.S. Application Data
(60) Provisional application No. 61/363,695, filed on Jul. 13, 2010.

(51) Int. Cl. G06F 19/00

(52) U.S. Cl. 702/19

(57) ABSTRACT

Systems and methods for accurately calculating radiation doses in biological tissues exposed to a radiation source are provided. In the systems and methods first, a radiation dose is computed to geometry of water equivalent medium of the biological tissues, expressed in computed tomography (CT) volumetric images. A Medium-Dependent-Correction factor that is a function of an effective bone depth matrix and the incident x-ray beam is obtained and tabulated. Using patient material and density data derived from CT images, the effective bone thickness can be calculated from a specific x-ray source. Finally, a Medium-Dependent-Correction factor that is a function of an effective bone depth matrix is used to accurately determine the radiation dose distributions to biological tissues.

### CROSS-REFERENCE TO RELATED APPLICATION

This application claims the benefit of Provisional Application Ser. No. 61/363,695 entitled “SYSTEM AND METHOD FOR ESTIMATING RADIATION DOSE AND DISTRIBUTION USING MEDIUM-DEPENDENT-CORRECTION BASED ALGORITHMS (MDC)”, filed Jul. 13, 2010, which is herein incorporated by reference in its entirety.

### FIELD OF THE INVENTION

Embodiments of the invention provide systems and methods for estimating radiation dose and distributions in biological tissues.

### BACKGROUND

Frequent and repeated imaging procedures such as those performed in image-guided radiotherapy (IGRT) and diagnostic CT procedures may add significant dose to patients. It has been shown that kilovoltage photon beams results in doses to bone, due to the photo-electric effect, are up to a factor of 3-4 higher than those in surrounding soft tissue. Imaging procedures are necessary due to their potential benefits, but the additional radiation also entails risk to patients. There have been a number of recent articles in the press related to tragic errors in radiation therapy. This combined with the recent publicity on CT perfusion dose problems has prompted Congress to call a hearing for a more standardized, comprehensive method of overseeing medical radiation, both diagnostic and therapeutic. The standardized and comprehensive method requires the documentation of radiation doses the patient received. Hence it is important to have an accurate calculation method to estimate the radiation to dose resulting from the imaging procedures.

Currently available model-based dose calculation methods are inaccurate and not suitable for low energy x-rays. Although the Monte Carlo method is accurate; the long computational times have prevented it from practical use.

### SUMMARY

This Summary is provided to present a summary of the invention to briefly indicate the nature and substance of the invention. It is submitted with the understanding that it will not be used to interpret or limit the scope or meaning of the claims.

A fast and accurate calculation algorithm is urgently needed for kilovoltage x-ray dose computations. Embodiments of the invention are directed to a dose calculation algorithm, referred to, herein, as effective bone depth algorithm for accurate patient dose calculation resulting from kilovoltage x-rays, and systems thereof. The accuracy of the new algorithm is validated against Monte Carlo calculations. The new algorithm overcomes the deficiency of existing density correction based algorithms in dose calculations for inhomogeneous media, especially for CT-based human volumetric images used in radiotherapy treatment planning.

In one embodiment, a system is provided. The system includes a radiation emitter; a radiation detector for detecting the radiation emitted from the radiation emitter; and a computer or processor running software for calculating an accurate dose of emitted radiation energy (D_{medium-dependent-corrected}) in a patient. The software includes an algorithm for calculating:

D_{medium-dependent-corrected}(x,y,z)=D_{density-corrected}(x,y,z)f_{MDD}(x,y,z)

where D_{density-corrected} is the dose distribution calculated with a convolution/superposition method and f_{MDC} is a Medium-Dependent-Correction factor, where f_{MDC} is a function of effective bone depth d_{EB}(x, y, z) matrix expressed by the following equation:

f_{MDC}(x,y,z)≡f_{c}(d_{EB})

where f, is a matrix of correction factor values for the system computed based on pre-defined correlation data between values for d_{EB}(x, y, z) and values for f_{c}.

In a second embodiment, a method for accurately calculating radiation doses in biological tissues exposed to a radiation source is provided. The method includes computing a dose deposition kernel using convolution/superposition dose calculations based on a configuration of the radiation source. The method further includes obtaining a raw geometry of the biological tissues expressed in computed tomography (CT) numbers. The method also includes determining the dose distribution (D_{medium-dependent-corrected}) in the biological tissues by calculating:

D_{medium-dependent-corrected}(x,y,z)=D_{density-corrected}(x,y,z)f_{MDC}(x,y,z)

where D_{density-corrected} is the dose distribution calculated with a model-base calculation method, such as convolution/superposition method for example and f_{MDC} is a Medium-Dependent-Correction factor, where f_{MDC} is a function of effective bone depth d_{EB}(x, y, z) matrix expressed by the following equation:

f_{MDC}(x,y,z)≡f_{c}(d_{EB})

where f_{c} is a matrix of correction factor values for the system computed based on pre-defined correlation data between values for d_{EB}(x, y, z) and values for f_{c}.

In a third embodiment, a computer-readable storage is provided. The computer-readable storage has stored thereon executable instructions that, when executed by a processor, cause the processor to perform various steps. The steps include computing a dose deposition kernel using convolution/superposition dose calculations based on a configuration of a radiation source; obtaining a raw geometry of biological tissues exposed to the radiation source expressed in computed tomography (CT) numbers; and determining the dose distribution (D_{medium-dependent-corrected}) in the biological tissues by calculating:

D_{medium-dependent-corrected}(x,y,z)=D_{density-corrected}(x,y,z)f_{MDC}(x,y,z)

where D_{density-corrected} is the dose distribution calculated with a convolution/superposition method and f_{MDC} is a Medium-Dependent-Correction factor, where f_{MDC} is a function of effective bone depth matrix d_{EB}(x, y, z) expressed by the following equation:

f_{MDC}(x,y,z)≡f_{c}(d_{EB})

where f_{c} is a matrix of correction factor values for the system computed based on pre-defined correlation data between values for d_{EB}(x, y, z) and values for f_{c}.

In the various embodiments, the emitted radiation can have a wavelength from about 1000 to about 0.0001 nanometers, frequencies in a range from about 300 petahertz to about 300 exahertz (3×10¹⁷ Hz to 3×10²⁰ Hz) and emitted energies from about 0.001 kilo electron volt (keV) to about 999 keV. For example, the emitted radiation, can have a kilovoltage range from about 1 kV to about 500 kV or a kilovoltage range from about 10 kV to about 200 kV.

In the various embodiments, the effective bone depth matrix can calculated by computing an average of a patient's bone thickness calculated for each ray.

In the various embodiments, a step of determining dose distribution can further include categorizing the CT numbers in the raw geometry to generate the medium geometry; and calculating d_{EB}(x, y, z) by computing an average of a patient's bone thickness calculated for each ray based on the medium geometry.

In some embodiments, the dose distribution expressed by D_{density-corrected}(x, y, z) can be a dose relative to water.

In the various embodiments, a radiation source can emit radiation having a wavelength from about 1000 to about 0.0001 nanometers, frequencies in a range from about 300 petahertz to about 300 exahertz (3×10¹⁷ Hz to 3×10²⁰ Hz) and emitted energies from about 0.001 kilo electron volt (keV) to about 999 keV. For example, the radiation source can emit radiation in a kilovoltage range from about 1 keV to about 500 keV or a kilovoltage range from about 10 keV to about 200 keV.

In some embodiments, instead of a convolution/superposition method to calculate the dose distribution D_{density-corrected}, D_{density-corrected} can be calculated based on x-ray fluence profiles and empirical x-ray scatter factors.

### BRIEF DESCRIPTION OF THE DRAWINGS

FIG. 1A shows the Monte Carlo calculated dose distribution in grayscale from 0-4 cGy.

FIG. 1B shows the dose distribution in grayscale from 0-4 cGy computed according to an embodiment.

FIG. 1C shows the comparison of the correction factors obtained between using a Monte Carlo method and a method according to the various embodiments along the horizontal line C-C shown in each of FIGS. 1A and 1B.

FIG. 2 shows the photon energy spectra for a CBCT 125 kVp beam with and without bow tie filters.

FIGS. 3A and 3B are graphs showing the calculated dose-volume histograms for specific radiosensitive organs within imaged volume respectively.

FIG. 4 is a schematic representation showing an embodiment of the method as a flowchart which illustrates the process and steps of application of the Medium-Dependant-Correction (MDC) algorithm to model based dose calculations resulting from diagnostic x-ray beams.

FIG. 5 shows an axial slice through the kV-CBCT image of an adult H&N patient.

FIG. 6 shows the dose correction factors for voxels in the slice shown in FIG. 5.

FIG. 7 shows an example of the effective bone depth distribution calculated for the axial slice shown in FIG. 5.

FIGS. 8A, 8B, 8C, and 8D are scatter plots showing the least squares fit relationships between f_{c}(x, y, z) and d_{EB}(x, y, z), for adult head and neck CT scan sites, pediatric head and neck CT scan sites, pelvic CT scan sites, and chest CT scan sites, respectively.

FIG. 8E is a scatter plot showing the combined results of FIGS. 8A-8D.

FIG. 9A shows the results of the application of a Monte Carlo algorithm to the calculation of imaging dose for pediatric head and neck cone-beam CT.

FIG. 9B shows the results of the application of an algorithm in accordance with and embodiment to the calculation of imaging dose for pediatric head and neck cone-beam CT.

FIG. 9C shows the results of the application of a model-based calculation of imaging dose for pediatric head and neck cone-beam CT.

FIGS. 10A-10D are graphs showing normalized DVH results calculated for individual organs resulting from pediatric H&N (FIGS. 10A-10B), and pelvis (FIGS. 10C-10D) CBCT scans, where solid lines were calculated with the gold standard Monte Carlo, dashed lines were calculated with the in accordance with an embodiment, and dot-dashed lines are model-based results.

FIG. 11 shows the dose planes calculated for a single kV-CBCT scan of patient adult H&N 4.

FIGS. 12A, 12B, and 12C show single kV-CBCT scan dose planes for the Adult Pelvis 3 patient using Monte Carlo, density correction, and MDC-EA calculation in accordance with the various embodiments, respectively.

FIG. 12D shows the line profiles for the Adult pelvis 3 patient along line AB in FIGS. 12A-12C.

FIG. 12E shows the line profiles for the Adult pelvis 3 patient along line CD in FIGS. 12A-12C.

FIGS. 13A, 13B, and 13C show single kV-CBCT scan dose planes through the thorax for the Adult Chest 2 patient using Monte Carlo, density correction, and MDC-EA calculation in accordance with the various embodiments, respectively.

FIG. 13D shows the line profiles along line AB in FIGS. 13A-13C.

FIG. 13E shows the line profiles along line CD in FIGS. 13A-13C.

FIG. 14 shows a table of the mean dose to bone, soft-tissue, and lung voxels calculated with the Monte Carlo, density-corrected-only, and MDC-EA techniques for each patient.

FIG. 15 shows a table of the mean and standard deviation dose errors normalized to the maximum soft-tissue dose to each patient calculated for the density-corrected-only calculations and the MDC-EA calculations for each patient.

FIGS. 16A-16F shows example dose error histograms for the Adult H&N 3 (FIGS. 16A and 16B), Adult Chest 4 (FIGS. 16C and 16D), and Pediatric Abdomen (FIGS. 16E and 16F) patients.

FIGS. 17A-17F shows dose-volume histograms (DVHs) for bone and soft-tissue structures for the Adult H&N 3 (FIGS. 17A and 17B), Adult Pelvis 2 (FIGS. 17C and 17D), and Adult Chest 4 patients (FIGS. 17E and 17F).

FIG. 18 is a plot showing the scatter dose deposition kernel used to calculate the dose to water-like media from scattered photons.

FIGS. 19A and 19B are plots of the dose planes showing the relative dose distributions calculated with Monte Carlo techniques and with an algorithm in accordance with an embodiment of the invention, respectively.

FIGS. 19C and 19D are plots of the depth-dose curves obtained with Monte Carlo techniques and with an algorithm in accordance with an embodiment of the invention, respectively.

FIGS. 20A and 20B are example calculation of the dose to water-like media for a full kV-CBCT scan of a 30×30×30 cm³ water phantom for a “gold-standard” Monte Carlo calculation and an algorithm in accordance with an embodiment of the invention, respectively.

FIG. 21 is a schematic of an exemplary imaging system for carrying out the various embodiments of the invention.

FIG. 22 is an exemplary computing system for carrying out one or more embodiments of the present invention.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. The present invention is not limited by the illustrated ordering of acts or events, as some acts may occur in different orders and/or concurrently with other acts or events. Furthermore, not all illustrated acts or events are required to implement a methodology in accordance with the present invention.

Computer-based modeling or simulation is well known in the art. Such simulations begin with the development of a model of a system that one wishes to test. Most often, the model comprises mathematical equations describing relationships between one or more input (independent) variables and one or more output (dependent) variables. By selecting specific values for the input variables, corresponding output values may be calculated for the output variables. In this manner, one can determine how the system, to the extent that it is accurately represented by the model, will respond to various situations represented by the input values.

One particularly technique for use with simulations is the so-called Monte Carlo analysis technique. In Monte Carlo simulations, a range of plausible input values is designated for each input variable. Likewise, a distribution for each input variable (i.e., a probability distribution function) is also designated. Thereafter, the Monte Carlo simulation generates random inputs for each input variable based on the designated range of values and distributions for the corresponding variables. The random input values are then used to calculate corresponding output values that are thereafter saved, whereas the input values are thrown away. This process is repeated many times, typically numbering in the hundreds or thousands of repetitions, and is used to create statistically meaningful distributions of one or more of the output variables. In this manner, the analyst performing the Monte Carlo simulation (typically the designer of the simulation model) can develop insight into how the model will perform under certain sets of assumed input conditions.

While Monte Carlo simulation techniques are very valuable, beneficial use of such techniques typically requires intimate knowledge of the underlying simulation model. Furthermore, to the extent that the output distributions are an aggregate of the multitude of tested scenarios, current Monte Carlo simulation tools provided only a limited opportunity to interact with, and therefore develop a true understanding of, the simulation model. Other drawbacks are also discussed below.

An x-ray image procedure entails risk to patients because it exposes the radiation to radiosensitive organs. In radiology, x-ray imaging, such as x-ray computerized tomography (CT), is more often used in diagnose the diseases because it helps to determine the illness and is widely available. In radiation therapy, image-guided procedures are performed much more frequently or daily due to the highly conformed target dose distribution which requires accurate patient positioning for radiation delivery.

Knowledge of radiation exposure to patient radiosensitive organs is becoming increasingly important for clinicians as information to make informed decisions and to manage the additional exposure to radiosensitive organs. The quantitative radiation exposure to patient specific organs is extremely useful not only because it is a patient health issue but also it provides actual clinical data to medical professionals and regulatory agencies in establishing guidelines related to performing x-ray image procedures.

However, heretofore, there has not been a dose calculation algorithm available that is fast and accurate for kV x-ray beams to meet the demand in clinical practice. The Monte Carlo method is accurate but its calculation speed is too slow to meet the requirement. The model based calculation algorithm is fast but its accuracy is unacceptable for kV x-ray beams. Embodiments of the invention are directed to a novel approach to calculate dose which overcomes the accuracy deficiency of model-based dose calculation method for kV x-rays. This new approach is not only fast but also accurate and meets or exceeds the requirements in providing a practical solution to solve this problem of time and accuracy, in clinical practice.

In conventional projection radiography, a source emits x-rays that are collimated to the region of interest on a patient, and a detector or film is placed behind the patient to detect the transmitted x-rays. The signal from the detector is then processed, or the film is developed, to create an image. Contrast between tissues in the body results from different rates of attenuation of x-rays within each tissue and is typically limited to differentiating between bone and soft-tissue, except in specialized applications such as mammography. Though useful in many situations, the diagnostic information from conventional x-ray imaging is limited because the intensity of the transmitted x-rays at the detector is a result of the integrated attenuation of the x-rays along the path from the x-ray source to the detector.

CT images are obtained by rotating a highly collimated x-ray source around the patient and having detectors record projection x-ray data from a multitude of angles throughout the rotation. Tomographic image reconstruction techniques are then used to create an axial cross-section image of the irradiated volume of the patient. Three-dimensional images can be constructed by translating the patient through the plane of the x-ray beam in either a stepwise or continuous motion, resulting in axial or helical scans respectively, which can be combined in a single 3D image set. Alternatively, x-ray beams wide enough to span the volume of interest can be used, as in cone-beam CT (CBCT), to create a 3D image with a single rotation of the x-ray source. Due to the higher degree of collimation of the x-ray beams typically used in CT, CT images provide increased soft-tissue contrast relative to conventional x-ray imaging.

The ability to image a patient in 3D and differentiate between soft-tissue structures in the body has led to the widespread use of CT in medicine. While the benefit of diagnostic information provided by CT is often critical for patient care, the radiation exposure to patients also entails the risks of carcinogenesis from the increased x-ray procedures from CT imaging. The radiation dose from imaging procedures is an increasingly important health issue as the public becomes aware of radiation exposure to patients, especially to pediatric patients, from repeated x-ray procedures in radiology. Additional bone dose from repeated image guided procedures when added to the radiotherapy doses may further increase the risk of bone malformation and growth issues associated with pediatric radiotherapy treatment protocols. In addition, radiotherapy has shifted to the new paradigm of image-guided radiotherapy (IGRT). X-rays in the diagnostic energy range are often used in IGRT. More than before, image procedures that provide 3D patient anatomy are used and the imaging dose is no longer limited to the imaged volume of interest as in the conventional portal image. The increased radiation exposure and the risk associated with it can no longer be ignored.

The risk of cancer then can be related to the amount of radiation exposure to a patient resulting from an x-ray imaging procedures. As discussed above, all currently available model-based dose calculation algorithms that may be adequate in the dose calculation for mega-voltage photon beams are incapable of calculating radiation dose from kilo-voltage x-rays leading to dose errors of up to 300% due to the increased photoelectric effect in doses to bone. The available model-based algorithms were developed for dose calculations resulting from Compton interaction, which mainly depend on the electron density of the medium and not the atomic number. This is an appropriate approximation for megavoltage beams where Compton scattering dominates photon interaction cross sections. However, in kilovoltage beams such as used in CT, photoelectric absorption replaces Compton scattering as the dominant interaction in materials with high atomic number, such as in bone. An earlier attempt of applying heterogeneity-corrected convolution dose calculations for kV x-rays was shown to be unsuccessful. Although Monte Carlo techniques are capable of calculating patient dose resulting from x-rays, the long computation times (days) are prohibitive for practical clinical use.

In the various embodiments of the invention, a Medium-Dependent-Correction (MDC) algorithm, is used overcome the deficiencies of dose calculations in existing model-based algorithms in the diagnostic energy range, especially for CT-based human volumetric images used in radiation treatment planning. The methodology retains the calculation speed of the current model based method that is widely used in commercial radiotherapy treatment planning systems for megavoltage photon beams, but its calculation accuracy is comparable to Monte Carlo techniques.

While the various embodiments will be described here principally with respect to human patients, this is solely for ease of illustration. The various systems and methods described herein can be used for estimating radiation dose and distribution in any type of biological tissues or synthetic analogues.

In the various embodiments, the MDC algorithm is applied to dose distributions calculated from using kernel based convolution/superposition dose calculation. This process is to correct for the effects of the various tissues due to their atomic number differences on dose distributions. Such a method would make incorporation of dose resulting from kV sources into dose calculation software utility practical and readily adaptable in clinical settings.

This process is achieved by taking a density corrected dose matrix and account for the effects of atomic number by multiplying correction factor:

D_{medium-dependent-corrected}(x,y,z)=D_{density-corrected}(x,y,z)f_{MDC}(x,y,z) (1)

Where D_{medium-dependent-corrected} is the dose distributions calculated with the MDC algorithm, D_{density-corrected} is the dose distribution calculated with convolution/superposition method, and f_{MDC} is the Medium-Dependent-Correction factor, which is a function of effective bone depth d_{EB}(x, y, z) and can be expressed by the following equation:

f_{MDC}(x,y,z)≡f_{c}(d_{EB}) (2)

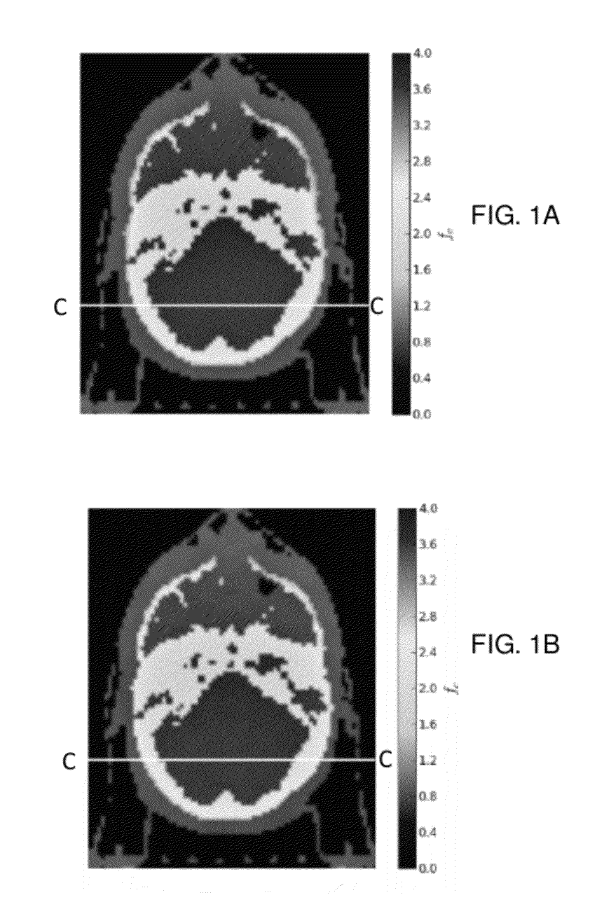

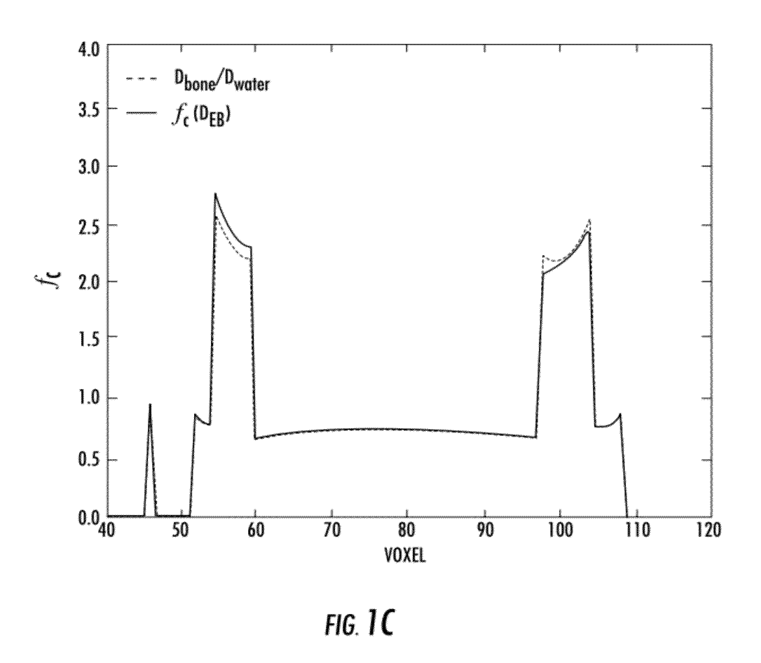

Using patient material and density data derived from CT images, the x-rays of a specific CT scan protocol, the effective bone thickness d_{EB}(x, y, z) can be calculated from that the x-ray beam penetrates to reach each voxel. The effective bone depth matrix is calculated by computing an average of the bone thicknesses calculated for each ray, weighted by a function that specifies the contribution of each of the individual rays to the effective depth at each voxel. The results are shown in FIGS. 1A, 1B, and 1C using this correction approach for real patient geometry. Specifically FIGS. 1A, 1B show the comparison of calculated dose distributions resulting from a kV-CBCT scan between the Monte Carlo method (“gold standard”) and the calculations obtained from the MDC methods described herein. FIG. 1C shows a comparison of the correction factors obtained using both methods. As shown in these figures, the differences are minor.

As described above, the model based dose calculations require information of incident x-ray beams. In order to accurately calculate the radiation dose from low-energy x-rays one must have the beam parameters of realistic incident beams. The best and the most efficient method to obtain a realistic incident beam parameters is by using Monte Carlo simulation techniques. The BEAM code has been used extensively to characterize therapy beams, including megavoltage electron and photon beams from linear accelerators and kilovoltage photon beams from x-ray units. Accordingly, Monte Carlo methods can be used to model the x-ray beams in the various embodiments without requiring significant amounts of calculation. However, the invention is not limited in this regard and other methods can be used.

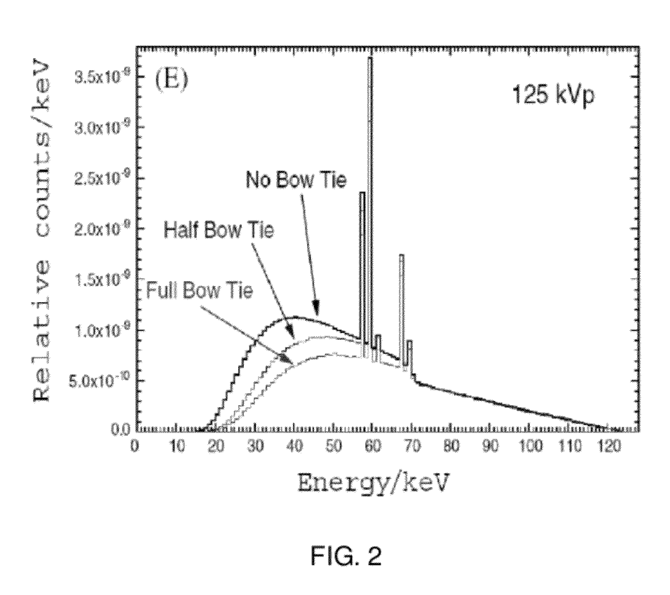

In general, there can be dramatic differences in the beam intensity and fluence distributions for the same x-ray beam when the beam is modified by different x-ray filters. FIG. 2 shows the variations in x-ray photon energy spectra when the same x-ray beam is incident on added filters as is common in cone-beam CT imaging. This demonstrates the importance of properly modeling low energy x-ray beams in order to obtain accurate beam parameters.

In some embodiments, the methodology can comprise calibrating an x-ray beam in order to calculate the dose to patients from image guided procedures. For example, previous studies have shown that a Monte Carlo simulated x-ray beam can be calibrated by phantom measurements according to the kV x-ray beam calibration dosimetry protocol. The application of the methodology for x-rays was benchmarked and validated against experimental measurements. The calibrated x-ray beam can be used to predict and to calculate the dose to patients resulting from x-ray imaging. This development made it possible to calculate patient organ dose on an individualized patient basis using real patient CT images. The issues with Monte Carlo calculations include the very long computational times (many hours) required that limit “real time” calculations for clinical practice. Therefore, if a fast and accurate model-based dose calculation method is available, the “real time” calculations of radiation exposure to patient will become reality in routine clinical practice. Embodiments of the invention comprise both extremely fast (e.g. real time) and accurate dose calculation of radiation required for subjecting a subject to radiation, for example, during imaging procedures, radiotherapy, and the like. The feasibility of calculation of organ dose by using the dose-volume-histogram (DVH) in radiotherapy treatment planning.

Accurate determination of x-ray imaging dose to each organ for patients has been of great interest because the radiation dose varies depending on the CT scan protocols used. One of the parameters methods used to report the radiation dose to an organ is the dose volume histogram (DVH). The inventors reported calculated dose volume histograms (DVH) from Monte Carlo calculated dose distributions resulting from typical kilovoltage cone-beam computed tomography (kV-CBCT) scans for child and adult patients.

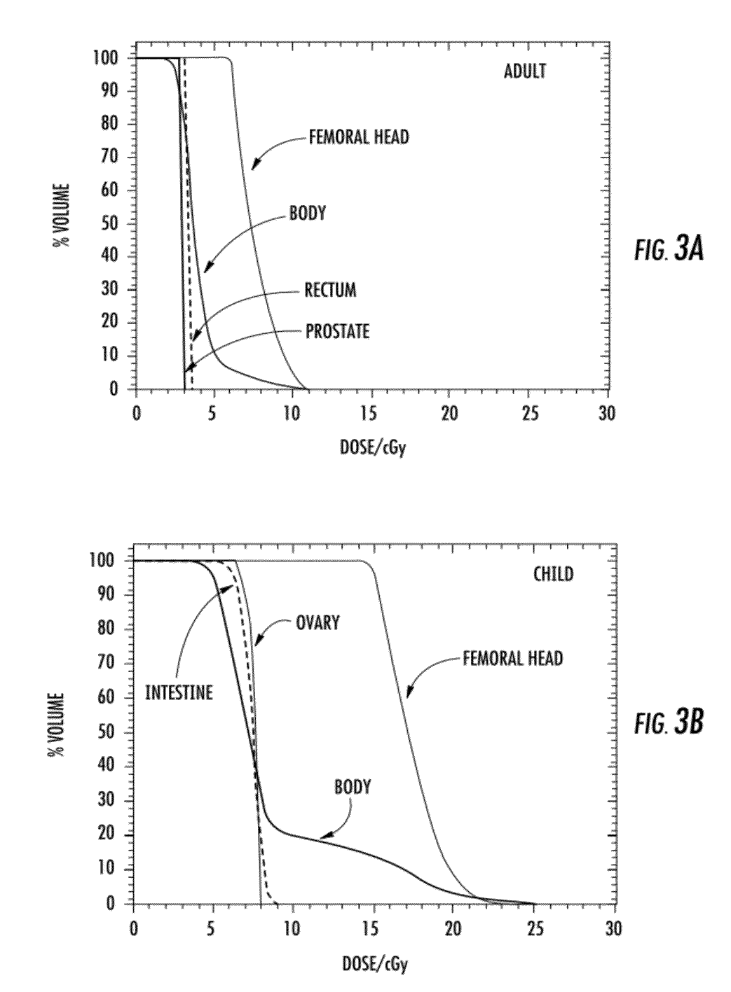

The results of DVH analyses provide details of x-ray imaging dose to each organ for abdominal kV-CBCT scans. FIGS. 3A, 3B shows the calculated DVHs for radiosensitive organs such as the femoral heads, prostate and ovary and the entire imaged volumes. The mean dose of 17 cGy to the femoral heads of the small child is higher than 7 cGy to the large adult patient. Large variation in organ dose between patients demonstrates the necessity of individualized patient dose calculations. This process uses a CT calibration curve, which provides the relationship between CT number and electron densities. The volumetric CT image with each voxel assigned to an electron density allows dose calculations with available model based convolution/superposition method by using kV x-ray sources.

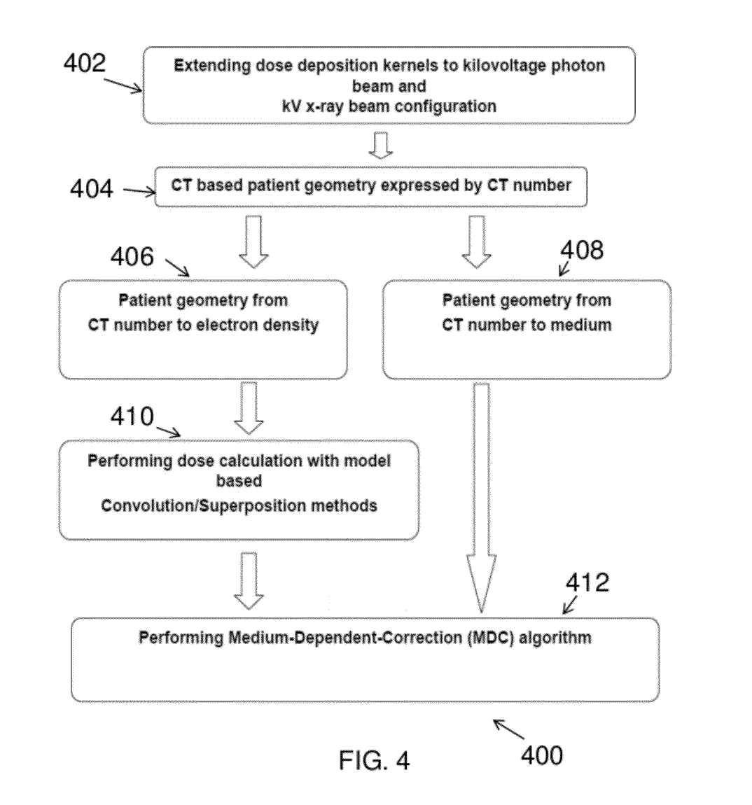

FIG. 4 is a schematic representation shown as a flowchart 400 which illustrates certain steps of application of the algorithm to model-based dose calculations resulting from x-ray imaging procedures. These steps are described below.

Step 402: Extending Dose Deposition Kernels to Kilovoltage Low-Energy X-Ray Beams

Dose deposition kernels available in current commercial radiotherapy treatment planning systems are generated by using Monte Carlo calculations and are suitable for megavoltage photon beam dose computations. Dose deposition kernels, also called dose spread arrays, describe the transport and deposition of energy by secondary electrons and photons produced by the interaction of primary photons with matter. In convolution-based dose computations, the primary energy fluence generated by the x-ray source, as well as scattered photons from the accelerator head, are calculated by the system and then convolved with the energy deposition kernels to produce a dose distribution. The kernels represent the energy transport and dose deposition of secondary particles stemming from a point irradiation. These kernels have been generated in the past for energies of 100 keV or higher for dose calculation of megavoltage photon beams. The dose deposition is viewed as a superposition of weighted responses (kernels) to point irradiations. Using the model based superposition method for dose calculations in the low-energy x-ray range of 60-130 kVp requires energy deposition kernels from 10 to 130 keV because the energy spectra of these beams contain energetic photons in this range. Dose deposition kernels for diagnostic quality x-rays can be generated accurately using Monte Carlo calculations and implemented in a commercial treatment planning system. The EGS4 Monte Carlo user code, SCAPHH, for generating the kernels in the energy range of 100 keV-50 MeV was developed and further modified for use in obtaining photon energy deposition kernels in the energy range of 20-110 keV.

Step 404: CT (Computed Tomography) Based Patient Geometry Expressed by CT Number

This process involves obtaining the CT number, (also called Hounsfield number) for each pixel of a volumetric CT image. The CT number used to represent the density of tissues assigned to a voxel in a CT scan on an arbitrary scale on which air has a density of −1000, water has a density of 0, and compact bone has a density of +1000. Thus, CT numbers use numerical information contained in each pixel of a volumetric CT image to relate to the composition and nature of the tissue imaged.

Step 406: Patient Geometry from CT Number to Electron Density

This process is already available in all commercial treatment planning systems when CT scans are used to correct for tissue inhomogeneities in 3D radiotherapy treatment planning. This process uses a CT calibration curve, which provides the relationship between CT number and electron densities. The volumetric CT image with each voxel assigned to an electron density allows dose calculations with available model based convolution/superposition method by using kV x-ray sources.

Step 408: Patient Geometry from CT Number to Medium

This process converts each voxel in the patient DICOM image from CT number to a specific material and density, which is not currently available in model-based commercial treatment planning systems. However, the method of generating volumetric patient geometry with medium-dependence from patient CT numbers is available and has been used in the Monte Carlo based dose calculations for real patient CT images. Although four materials (air, lung, tissue and bone) are generally used in converting from a CT number to a specific medium for patient CT based dose calculations, the fitting parameters only need to be optimized for bone and soft tissue. This is because the differences in the mass-energy absorption coefficient are small among the air, lung and soft tissues. More than four materials can be included if they can further improve the calculation accuracy. For each patient, each voxel in the diagnostic CT or CBCT images preferably are converted from a CT number to a specific material. The volumetric CT image with each voxel assigned to an organ material (air, lung, tissue and bone) allows calculation of effective bone depth matrix in order to obtain correction factors.

Step 410: Dose Calculations with Model Based Convolution/Superposition Method by Using kV X-Ray Sources

This process is performed using the available point kernel based dose calculation methods. The calculated dose distributions expressed by D_{density-corrected}(x, y, z) are dose to water-equivalent medium with electron density correction applied. The density correction methods are currently used to account for the effect that the various tissue densities have on dose deposition due to beam attenuation.

Once the above-mentioned steps are performed, the MDC algorithm can be performed at step 412, as described above. Using patient material and density data derived from CT images, the x-rays of a specific CT scan protocol, the effective bone thickness d_{EB}(x, y, z) can be calculated from that the x-ray beam penetrates to reach each voxel.

Benchmarking the accuracy of the Effective Approach Medium-Dependant-Correction (EA-MDC) algorithm: As shown in FIGS. 1A, 1B, and 1C a comparison of calculated dose distributions performed between Monte Carlo simulations and the MDC algorithm shows the calculation accuracy of the MDC algorithm. Specifically, FIG. 1C shows the similarity between the correction values for each method.

Normally, the Monte Carlo techniques can be used to perform dose calculations to obtain two dose distributions for the same patient geometry of CT images, D_{medium}(x, y, z) and D_{water}(x, y, z). The dose distribution matrix D_{medium}(x, y, z) is the calculated imaging dose-to-medium delivered to patients from kV-CBCT scans, while D_{water}(x, y, z), is the calculated dose-to-water that is computed instead of dose-to-medium by setting all materials in the calculation volume to water with the density obtained from CT data. Thus, a matrix of correction factors that converts the dose-to-water to dose-to-medium, f_{c}(x, y, z) can be obtained by taking the ratio of the doses to corresponding voxels resulting from each calculation:

$${f}_{c} ( x , y , z ) = \frac{{D}_{m} ( x , y , z )}{{D}_{w} ( x , y , z )} \qquad ( 3 )$$

However, in the various embodiments, patient material and density data derived from CT images, for the x-rays of a specific scan protocol, can be used to calculate the effective bone thickness from the x-ray beam that penetrates to reach each voxel, d_{EB}(x, y, z). This is done by segmenting the rotation of the x-ray source into a set of evenly spaced incident rays and calculating the thickness of bone, that the primary x-rays passed through to reach each voxel from each ray. The effective bone depth matrix is calculated by computing an average of the bone thicknesses calculated for each ray, weighted by a function that specifies the contribution of each of the individual rays to the effective depth at each voxel.

Using patient material and density data derived from CT images, the x-ray beam fluence profile, and the imaging isocenter, the effective bone depth that the x-ray beam penetrates to reach each voxel, d_{EB}(x, y, z) was calculated. This quantity was calculated by first modeling the rotating x-ray source of the OBI system used for kV-CBCT acquisition as a set of evenly spaced incident rays and calculating the thickness of bone, d_{B}, that each ray passes through to reach each voxel. The effective bone depth was then calculated for each voxel by computing an average of the bone thicknesses for each ray to reach each voxel, weighted by a function that specifies the contribution of each of the individual rays to the effective depth at each voxel

$${d}_{EB} ( x , y , z ) = {\sum }_{i} {w ( x , y , z )}_{i} \cdot {{d}_{B} ( x , y , z )}_{i} , \qquad ( 4 )$$

where the sum in Equation 4 is over each incident ray. The weighting function, w, depends on the x-ray beam fluence profile (I(x,y,z)), the source-to-voxel distance (SVD(x,y,z)), and the bone thickness for each incident ray. The weighting function used was:

$$w ( x , y , z ) = \frac{I ( x , y , z )}{{{d}_{B} ( x , y , z )}^{2} + {cSVD ( x , y , z )}^{2}} , \qquad ( 5 )$$

where c is a constant used to scale the relative weight of SVD and d_{B}, and was taken to be 1/400. However, the various embodiments are not limited in this regard and other weighting functions can be used.

For each kV-CBCT acquisition technique except for the OBI 1.4 Standard-Dose Head, a 360° rotation of the x-ray source was used, and was modeled by utilizing 16 incident rays separated by 22.5° to calculate the effective bone depth. We found that there was a negligible difference in effective bone depth distributions if the number of incident rays was increased from 16 to 360. The Standard-Dose Head technique utilizes a 200° posterior arc of the x-ray source with x-ray incidence spanning from a supine patient's left lateral side to a right anterior oblique incidence. This 200° arc was modeled using 10 incident beams separated by 20° to calculate the effective bone depth.

Monte Carlo simulation and effective bone depth calculations were carried out as described above for the real patients. In at least one case, these patients were divided into two groups: (1) four patients were used to derive correction factor curves from the correlation between the effective bone depth and dose correction factor, and (2) ten patients were used as test cases to validate the use of the curves for dose calculation. The imaging sites for the first data set included an adult H&N, a pediatric H&N, an adult pelvis, and an adult chest. The remaining patients used for validation included imaging sites such as the adult H&N, chest, pelvis, pediatric abdomen, and the legs.

To derive correction factor curves as a function of effective bone depth, the “gold standard” correction factors and corresponding effective bone depths for all voxels of all patients in group 1 were combined into a single data set. This data set was then investigated to obtain a general correlation of the correction factor as a function of effective bone thickness individually for bone and soft-tissue:

$${f}_{c} ( {d}_{EB} ) = \{ \begin{matrix}{f}_{c}^{bone} ( {d}_{EB} ) , & bone voxels \\ {f}_{c}^{soft \text{-} tissue} ( {d}_{EB} ) , & soft \text{-} tissue voxels .\end{matrix} \qquad ( 5 )$$

The derived curves were used for dose calculation for each patient by calculating the effective bone depth distributions and applying the resulting correction factor to the density-corrected-only calculation:

D_{M}(x,y,z)=D_{DCO}(x,y,z)f_{c}(d_{EB}(x,y,z)). (6)

Validation of the dose calculations was performed by comparing the resulting dose distributions to Monte Carlo dose distributions calculated for each patient.

Monte Carlo Simulation of Dose Correction Factors

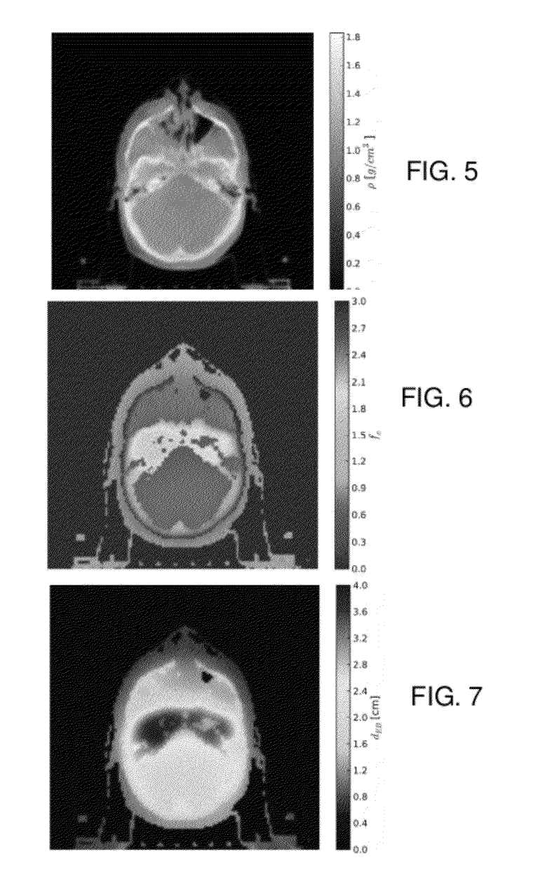

FIG. 5 shows an axial slice through the kV-CBCT image of an adult H&N patient. FIG. 6 shows the dose correction factors for voxels in this slice. Dose correction factors are generally greater than one for bone voxels and are typically in the range of 2-3. Soft-tissue voxels generally have dose correction factors less than one. Bone voxels on the periphery of the skull have the largest correction factors, as the primary x-ray beam has not been attenuated by bone prior to irradiation of these voxels for a portion of the rotation of the x-ray source around the skull. Voxels interior to the skull tend to have smaller correction factors as the low energy x-ray fluence is heavily depleted at these locations due to photoabsorption in bone.

FIG. 7 shows an example of the effective bone depth distribution calculated for the axial slice shown in FIG. 5. High effective bone depth was calculated in regions in or near thick bones; lower values of effective bone depth are seen in the soft-tissues in the periphery of the patient, and on the most exterior bone surfaces. The effective bone depth distribution shown in FIG. 7 was calculated using the 16 incident rays separated by 22.5° as described in Section 2.1. We performed similar calculations with 4, 8, 32, 64, and 360 incident rays and found that calculations using less than 16 rays resulted in effective bone depth distributions that inadequately characterized the distribution of bone in the patient, and calculations using more than 16 incident rays did not show significant improvement to justify the additional calculation time.

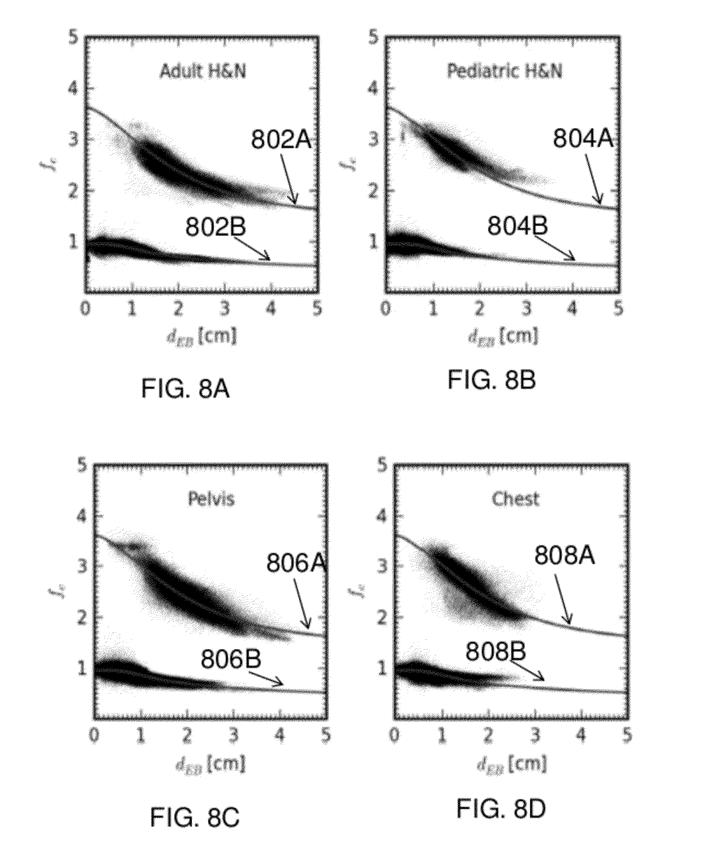

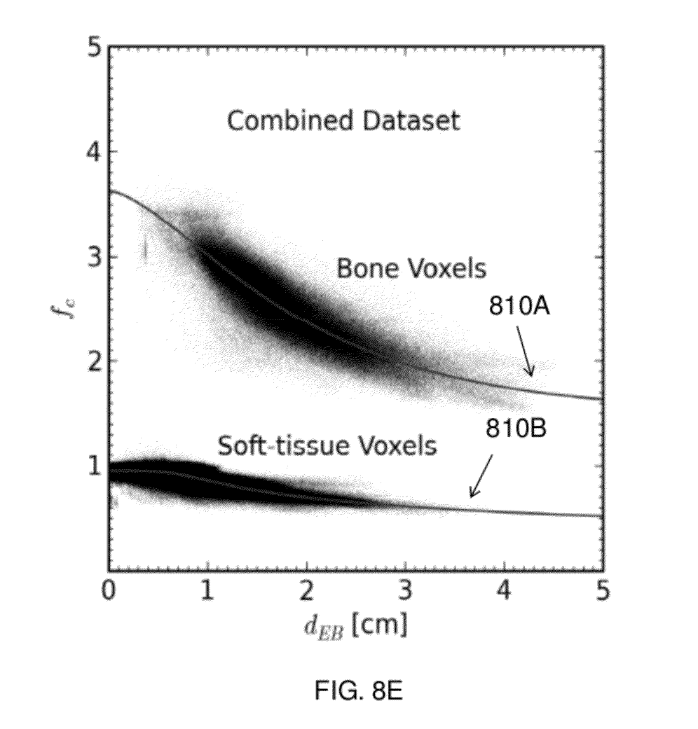

Dose correction factors and effective bone depth distributions were calculated for each of the patients in the first data set with the intent of correlating the two quantities. When the Monte Carlo-calculated matrix of correction factors f_{c}(x, y, z) was plotted as a function of the effective bone thickness d_{EB}(x, y, z) for all the voxels of bones and soft tissues, it was found that there was a close relationship between f_{c}(x, y, z) and d_{EB}(x, y, z) as shown in FIGS. 8A-8E. FIGS. 8A, 8B, 8C, and 8D show the relationships between f_{c}(x, y, z) and d_{EB}(x, y, z), for adult head and neck CT scan sites, pediatric head and neck CT scan sites, pelvic CT scan sites, and chest CT scan sites, respectively. FIG. 8E shows the combined results of FIGS. 8A-8D. In particular, FIGS. 8A-8E show scatter plots demonstrating that correction factors f_{c}(x, y, z) are correlated with the calculated effective bone depth. Further, 8A-8E show curves 802A, 804A, 806A, 808A, and 810A, respectively, showing the least squares fit that gives the correction factors as a function of the effective bone depth for bone voxels. Additionally, 8A-8E show curves 802B, 804B, 806B, 808B, and 810A, respectively, showing the least squares fit that gives the correction factors as a function of the effective bone depth for soft tissue voxels.

Each point in each of FIGS. 8A-8E corresponds to a single voxel. In total, this plot shows data from nearly 3×10⁵ bone voxels and more than 3×10⁶ soft-tissue voxels. As noted above, the curves 802A-810B are least-square fits to the combined data sets and give the dose correction factors as a function of effective bone depth separately for bone and soft-tissue voxels. For the data in FIGS. 8A-8E, the equations for these curves are:

$$\begin{matrix}{f}_{c}^{bone} = 3.6258 - 2.1422 [ 1 - {( 1 + {( \frac{{d}_{EB}}{4.4518} )}^{1.5171} )}^{- 3.3769} ] & ( 7 ) \\ {f}_{c}^{soft \text{-} tissue} = {( 2.0953 + 6.7997 {d}_{EB}^{4.5429} )}^{0.07178} . & ( 8 )\end{matrix}$$

The results of FIGS. 8A-8E are significant because it indicates that the correction factors f_{c}(x, y, z) can be obtained from the effective bone thickness d_{EB}(x, y, z). Since the parameters of the effective bone thickness d_{EB}(x, y, z) for soft tissue and bone voxels can be calculated for an x-ray beam of a specific CT scan protocol, the correction factor f_{c}(x, y, z) can be obtained from the fitted curves in FIGS. 8A-8E, and more particularly from the curves 810A and 810B in FIG. 8E.

The resulting accuracy of the correction factors obtained from the effective bone thickness is shown in FIGS. 1A-1C, as described above. This initial study demonstrated that results obtained by the approaches herein, are not only fast but also accurate. With the ability to make dose calculations in “real time” this is of crucial clinical importance in that the radiation exposure can be limited to amounts that are accurate and do not expose patients to unwarranted doses of radiation resulting from x-ray imaging procedures.

It is important to note that although both Monte Carlo and this new algorithm provide accurate dose distributions it took only minutes to calculate by using the approach herein, while the Monte Carlo calculation took several days for the results shown in FIGS. 1A-1C. A fast and accurate dose calculation algorithm is crucial in clinical practice because doses to organs have to be patient specific. The radiation exposure to organs depends on patient size and imaged locations. The data obtained by the methods herein, evidence that these requirements are met and thus provide a solution to solve this problem in clinical practice.

Accordingly, the resulting correlation between correction factor fc (x, y, z) and the effective bone thickness dEB (x, y, z) can be exploited to eliminate and/or reduce the need for performing extensive Monte Carlo simulations for an x-ray beam or source or interest. Specifically, for the x-ray beam of interest, correction factor fc (x, y, z) values as a function of effective bone thickness dEB (x, y, z) values are first determined by Monte Carlo methods. This calculation can be part of a calibration process for the x-ray source. Further, this data can be calculated only once. That is, the values do not need to be calculated for each patient, as the values are x-ray beam energy dependent, not patient specific values. Accordingly, this data can be subsequently used by MDC methods described herein to quickly perform the dose calculations for any patients exposed to the x-ray beam. That is, rather than performing Monte Carlo simulations for each patient in order to determine doses, as in conventional methods, the effective bone thickness dEB (x, y, z) values can be computed directly from the CT data of the patient. Thereafter, correction factor fc (x, y, z) values can be computed from the stored correlation data and dose can be accurately computed for the patient.

The algorithms can be implemented in a software utility that allows the user to report and to document radiation doses to patients in “real time”. The software is capable of predicting the radiation dose to each organ including the dose to bone marrow from either a diagnostic imaging procedure in radiology or a repeated image guidance procedure in image-guided radiation therapy (IGRT).

### First Example Using Patient Data

Using Monte Carlo simulation, the imaging dose delivered to real patients from head-and-neck (H&N), pelvis, and chest CBCT scans, was calculated. Two separate calculations were performed for each patient; one in which both electron density and atomic number inhomogeneities were considered, and one in which electron density alone was considered. The ratio of the two dose distributions is the voxel-by-voxel correction factor, fc, needed to correct the density corrected dose distribution for the affects of photo-absorption.

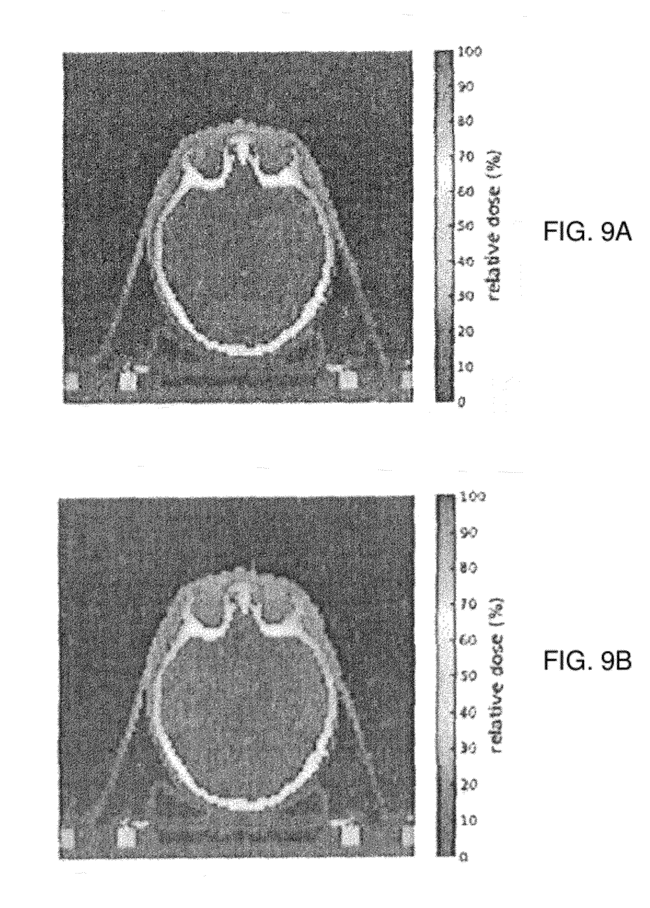

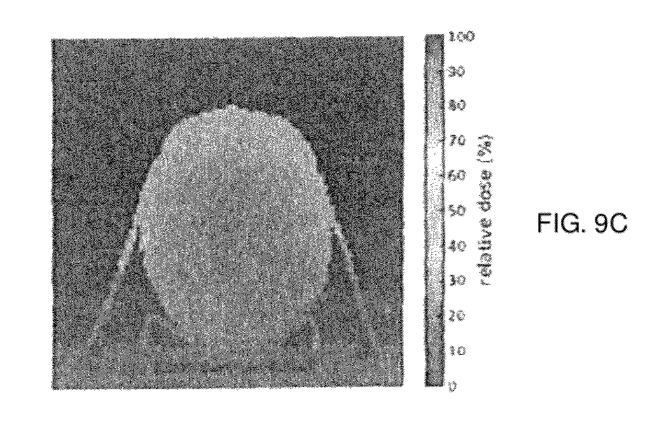

FIGS. 9A-9C shows the results of the application of the developed algorithm to the calculation of imaging dose for pediatric head and neck cone-beam CT. The Monte Carlo calculated dose distribution in FIG. 9A shows enhanced dose to the skull and reduced dose to soft-tissue relative to model-based calculations (FIG. 9C). The distribution in FIG. 9B was obtained by application of the developed algorithm and shows qualitative agreement with the Monte Carlo calculated dose distribution. The results of the model-based calculation (FIG. 9C) show that the currently available method is unable to calculate imaging dose from kV x-rays, most prevalently for bone anatomy.

The distribution of errors for each patient was characterized by the mean dose error averaged over each voxel, δ, and the standard deviation of the voxel-by-voxel dose error, σ. Table 1 shows these values for each patient dose calculation. All errors were normalized to the maximum dose to soft-tissue calculated with the Monte Carlo method, which is typically 2-3 times lower than the dose to bone. With the algorithm applied to each patient, mean dose error was within 3% for bone and 2% for soft-tissue. This is in contrast to the model-based calculation, which resulted in significantly higher errors of up to −103% for bone, and 8% for soft-tissue. These results show that a single set of calibration curves for bone and soft-tissue can accurately estimate imaging dose from kV x-rays, regardless of imaging location or patient type.

Table 1 shows a comparison of the new approach and model based dose calculation. Mean (⁻δ) and standard deviation (σ) dose errors relative to Monte Carlo are tabulated for bone and soft-tissue for each calculation. Dose errors were normalized to the maximum soft-tissue dose calculated with Monte Carlo.

TABLE 1
Comparison of the MDC approach and model based dose calculation.

| | δ̅_{bone} | | δ̅_{soft-tissue} | | σ_{bone} | | σ_{soft-tissue} | |
|---|---|---|---|---|---|---|---|---|
| | [%] | | [%] | | [%] | | [%] | |
| Patient | NA^{a} | MB^{b} | NA | MB | NA | MB | NA | MB |
| Adult H&N | 0.2 | −82.1 | 1.8 | 8.2 | 13.6 | 28.1 | 4.1 | 6.6 |
| Pediatric H&N | −1.8 | −102.6 | 1.0 | −1.5 | 9.5 | 27.8 | 2.7 | −1.3 |
| Pelvis | −2.4 | −62.8 | −1.3 | 3.5 | 12.0 | 31.0 | 3.0 | 3.2 |
| Chest | 0.5 | −72.7 | 0.0 | 3.3 | 8.3 | 32.0 | 1.9 | 2.8 |

^{a}new approach
^{b}model-based

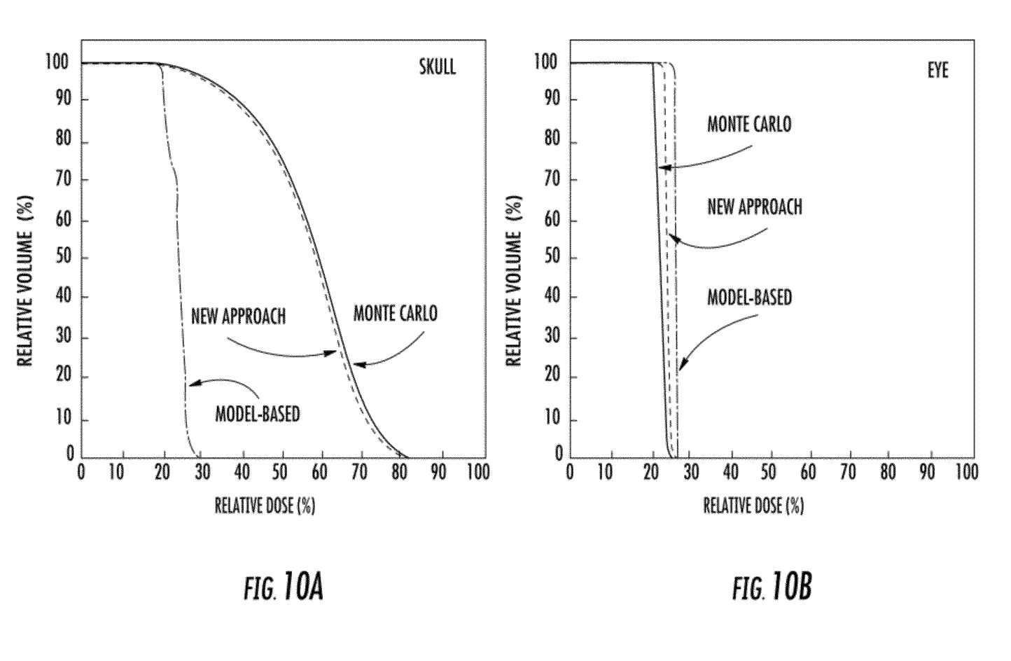

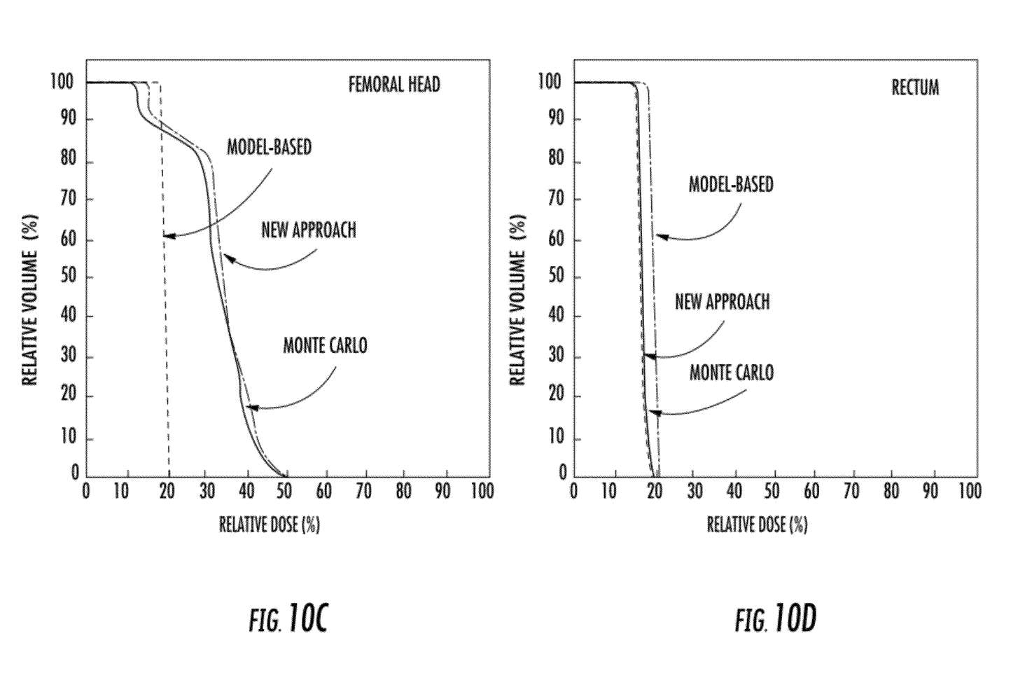

The accuracy of the MDC algorithm was also studied in the context of treatment planning by examining organ doses using dose-volume histograms (CVHs). FIGS. 10A-10D show DVHs calculated for various structures for a pediatric head and neck scan (FIGS. 10A, 10B) and an adult pelvis scan (FIGS. 10C, 10D). Solid curves are the gold-standard Monte Carlo calculated DVHs, dashed curves were calculated with the new approach, and dot-dashed curves were model-based results.

The skull DVH in Figure A shows that the current model-based calculation drastically underestimates the dose to the skull whereas application of the MDC algorithm accurately predicts the dose distribution of the skull. Similarly for the femoral head (FIG. 10C) the model-based correction is incapable of accurately calculating these doses. The soft-tissue structures reveal the opposite to be true for soft-tissue: model-based calculations overestimate the dose to soft-tissue, which is compensated for by applying the derived correction factors. These results were typical of all structures examined for each patient.

### Second Example using Patient Data

A second study was conducted based on the patients listed below in Table 2 and according to the acquisition techniques listed therein.

TABLE 2
kV-CBCT acquisition techniques used for dose calculation
for each patient for the second example.

| | CBCT Acquisition | X-ray Voltage |
|---|---|---|
| Patient | Technique | (kVp) |
| Adult H&N 1* | OBI 1.3 | 125 |
| | OBI 1.4 Standard-Dose | |
| Adult H&N 2 | Head | 100 |
| | OBI 1.4 Standard-Dose | |
| Adult H&N 3 | Head | 100 |
| | OBI 1.4 Standard-Dose | |
| Adult H&N 4 | Head | 100 |
| Pediatric H&N* | OBI 1.3 | 125 |
| Adult Pelvis 1* | OBI 1.3 | 125 |
| Adult Pelvis 2 | OBI 1.4 Pelvis | 125 |
| Adult Pelvis 3 | OBI 1.4 Pelvis | 125 |
| Adult Chest 1* | OBI 1.3 | 125 |
| Adult Chest 2 | OBI 1.4 Low-Dose Thorax | 110 |
| Adult Chest 3 | OBI 1.4 Low-Dose Thorax | 110 |
| Adult Chest 4 | OBI 1.4 Low-Dose Thorax | 110 |
| Adult Legs | OBI 1.4 Pelvis | 125 |
| Pediatric Abdomen | OBI 1.4 Low-Dose Thorax | 110 |

*Patients used to derive correction factor curves.

Each kV-CBCT x-ray beam simulated was from Varian's OBI system.

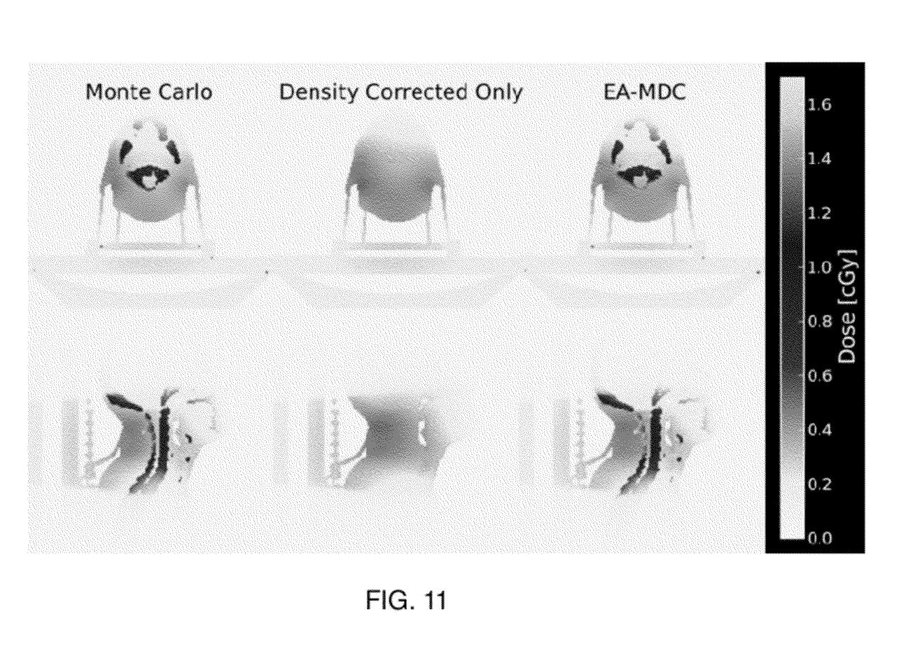

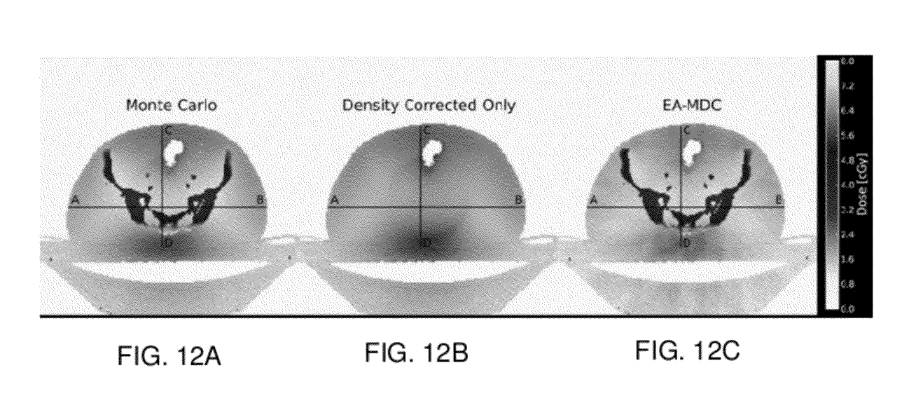

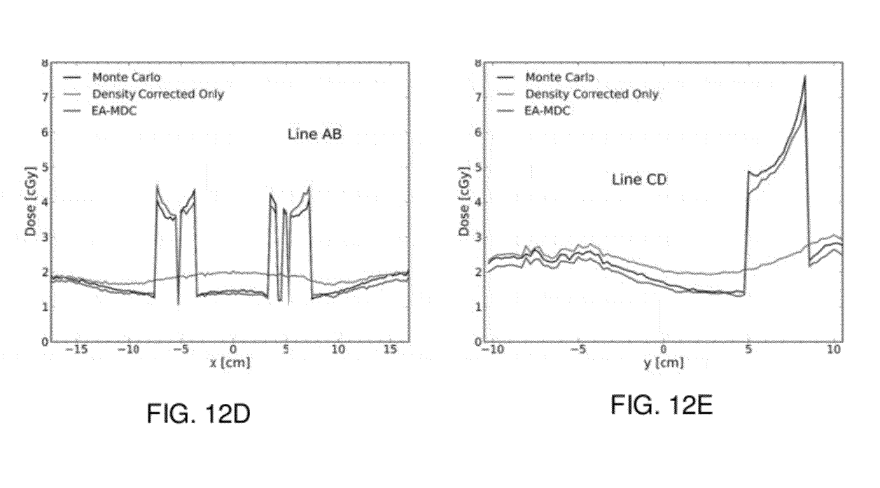

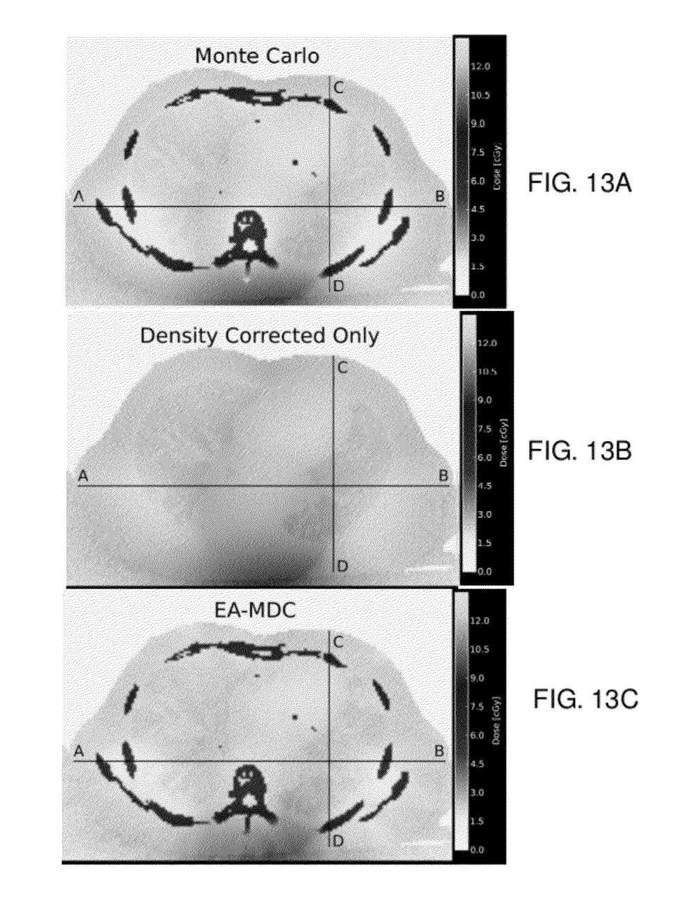

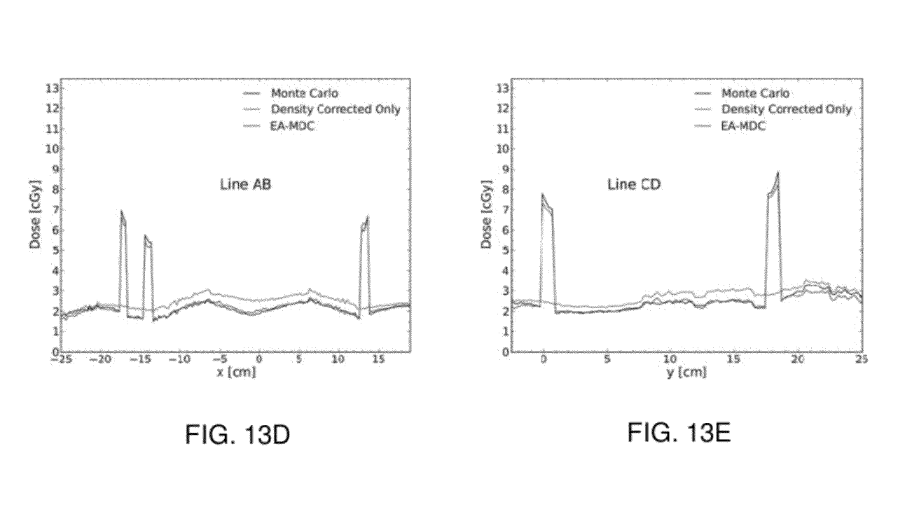

Dose calculations were carried out as described above using Equations 7 and 8 to convert effective bone depth to dose correction factor. Example calculated dose distributions are shown in FIGS. 11, 12A-E, and 13A-13E for the Adult H&N 4, Adult Pelvis 3, and Adult Chest 2 patients, respectively. FIG. 11 shows the dose planes calculated for a single kV-CBCT scan of patient adult H&N 4. In particular, axial (top) and sagittal (bottom) planes are shown for the Monte Carlo calculation (left), the density-corrected-only calculation (middle), and the MDC-EA calculation (right). The kV-CBCT acquisition mode used was the OBI 1.4 Standard Head with a full bow-tie filter and 200° posterior rotation of the x-ray source. FIGS. 12A, 12B, and 12C show single kV-CBCT scan dose planes for the Adult Pelvis 3 patient using Monte Carlo, density correction, and MDC-EA calculation in accordance with the various embodiments, respectively. FIG. 12D shows the line profiles for the Adult pelvis 3 patient along line AB in FIGS. 12A-12C. FIG. 12E shows the line profiles for the Adult pelvis 3 patient along line CD in FIGS. 12A-12C. FIGS. 13A, 13B, and 13C show single kV-CBCT scan dose planes through the thorax for the Adult Chest 2 patient using Monte Carlo, density correction, and MDC-EA calculation in accordance with the various embodiments, respectively. FIG. 13D shows the line profiles along line AB in FIGS. 13A-13C. FIG. 13E shows the line profiles along line CD in FIGS. 13A-13C.

The dose calculation for Adult H&N 4 was performed with the OBI 1.4 Standard-Dose Head scanning technique which utilizes a 200° posterior rotation of the x-ray source. The Monte Carlo calculations show the enhanced dose to bone, which is most prominent in the regions which are directly irradiated by the primary x-ray beam. The density-corrected-only calculations result in a relatively homogeneous dose distribution as photoabsorption in bone is not accounted for. The MDC-EA calculations correct for the effects of photoabsorption in bone on the dose distribution by enhancing the dose to bone and decreasing the dose to the surrounding soft-tissues. Note from the profile along line AB in FIG. 12D that the dose-to-medium does not always trend with the density-corrected-only distribution. Simple application of a constant multiplicative correction factor would incorrectly predict the shape of the Monte Carlo distribution; however, the MDC-EA accurately models the dose-to-medium. The thoracic CT scan dose planes and profiles shown in FIGS. 13A-13E show that the MDC-EA is capable of accurately calculating the radiation dose to lung, as well as other soft-tissues and bone.

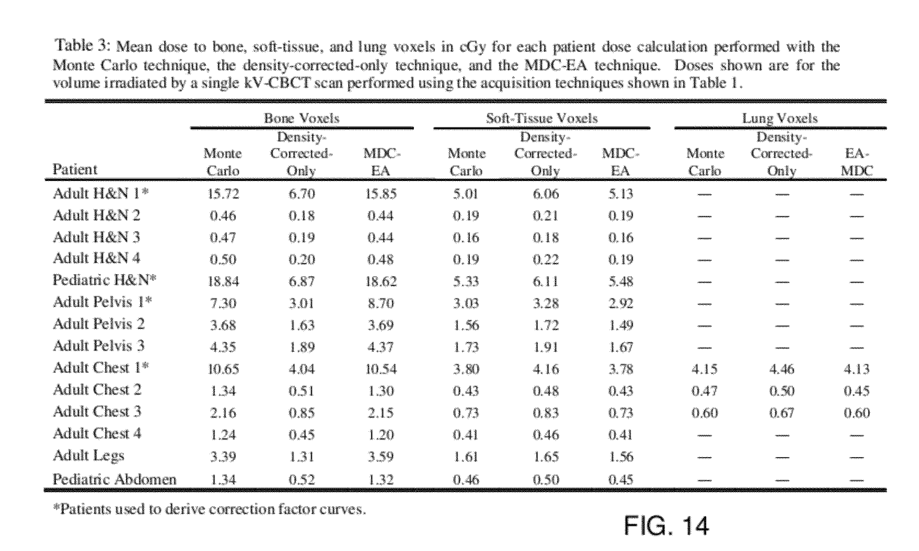

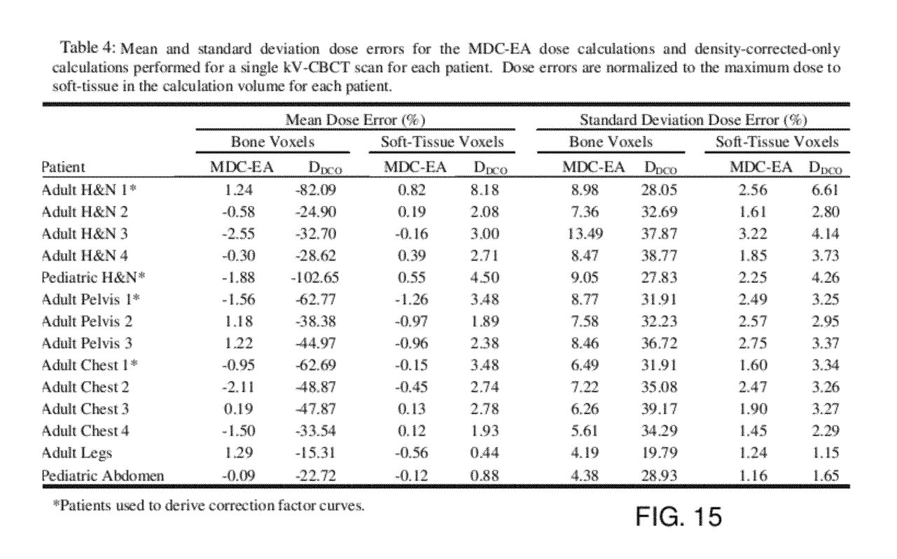

Table 3 shows the mean dose to bone, soft-tissue, and lung voxels calculated with the Monte Carlo, density-corrected-only, and MDC-EA techniques for each patient. Table 3 is shown in FIG. 14. The magnitude of the imaging dose depends on imaging site, patient size, and acquisition technique, varying by roughly an order of magnitude across all patients studied. An examination of the accuracy of the MDC-EA across this group of patients is thus easiest done in a relative fashion. Table 4 shows the mean and standard deviation dose errors normalized to the maximum soft-tissue dose to each patient calculated for the density-corrected-only calculations and the MDC-EA calculations for each patient. Table 4 is shown in FIG. 15. The density-corrected-only calculations result in mean bone dose errors up to −103%, with standard deviations of the distributions approaching nearly 40%. The MDC-EA is capable of correcting the mean bone dose to within 2.55% for all patients and the standard deviation dose errors to within 13.49%. The density-corrected-only calculations produced mean dose errors of up to 8.18% for soft-tissue voxels, whereas the MDC-EA corrected each distribution to within 1.26% of the “gold-standard”. The standard deviation dose errors for the soft-tissue voxels were as high as 6.61% for the density-corrected-only calculations, but were within 3.22% for the MDC-EA calculations.

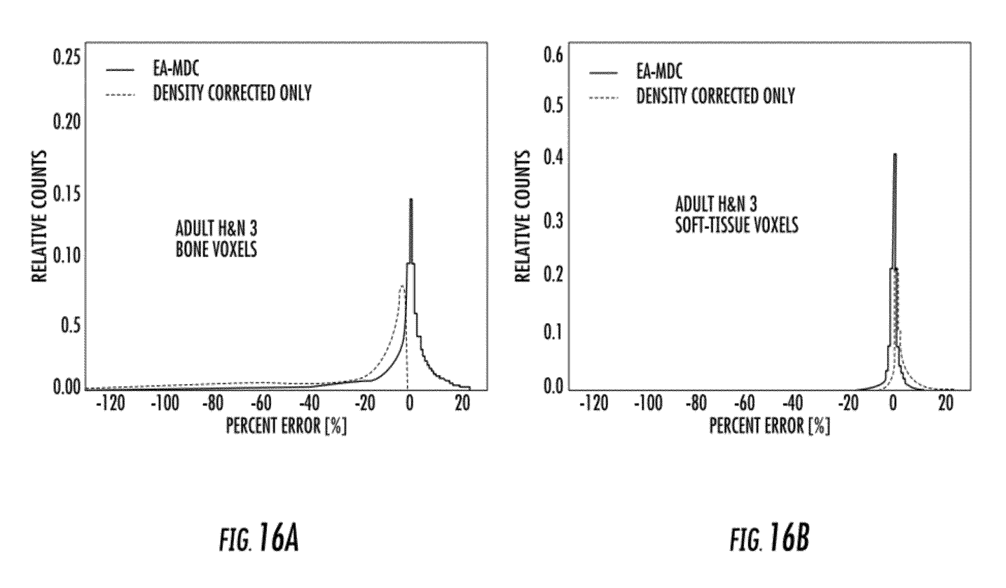

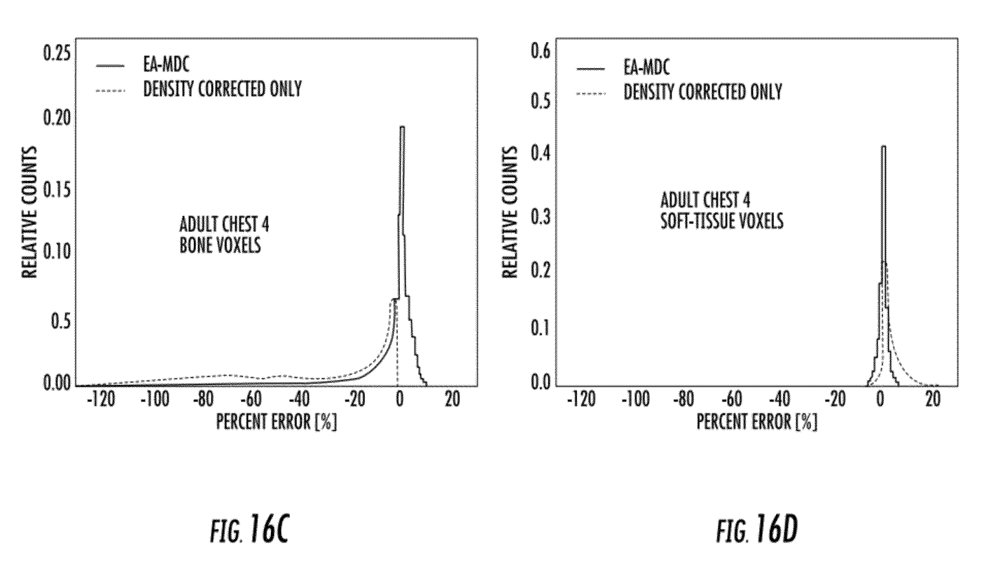

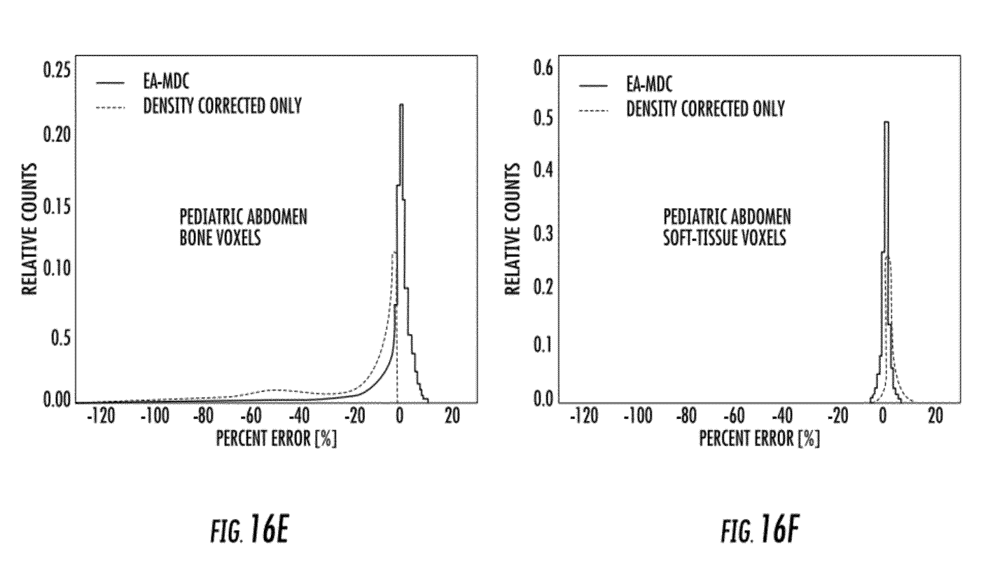

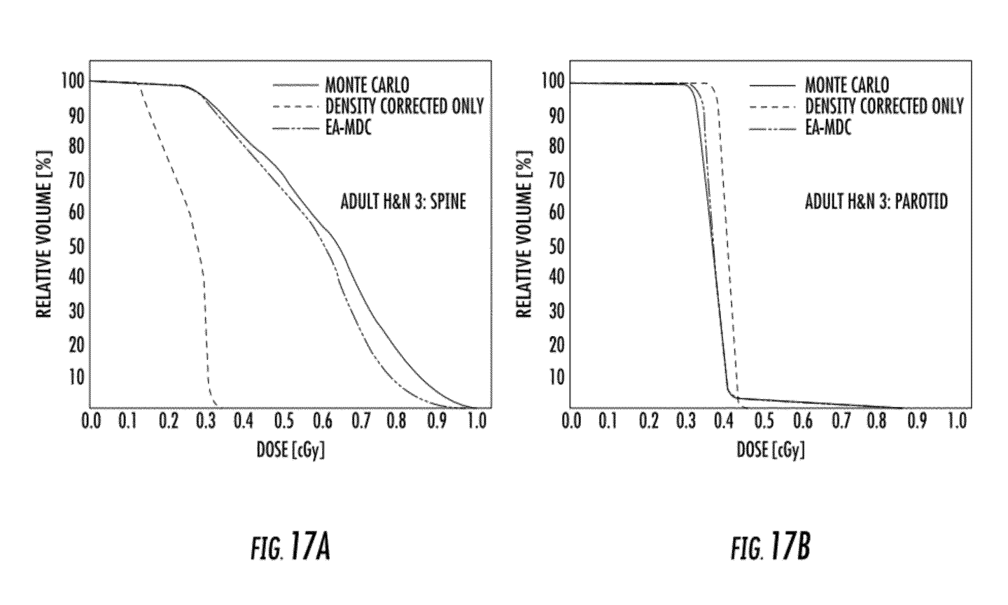

FIGS. 16A-16F shows example dose error histograms for the Adult H&N 3 (FIGS. 16A and 16B), Adult Chest 4 (FIGS. 16C and 16D), and Pediatric Abdomen (FIGS. 16E and 16F) patients. Bone error distributions (FIGS. 16A, 16C, and 16E), and soft-tissue error distributions (FIGS. 16B, 16D, and 16F) are shown for each patient for the density-corrected-only and MDC-EA calculations. The distributions were calculated relative to the maximum dose to soft-tissue for each patient. The density-corrected-only calculations produce bone error distributions with long negative dose error tails as the enhanced dose to bone from photoabsorption is not accounted for in these calculations. The MDC-EA calculation both centered the bone dose error distribution about 0% and significantly reduced the spread in the dose-error distribution, as was indicated in Table 3. Similar results are shown for soft-tissue, though the magnitude of dose correction is less than that for bone.

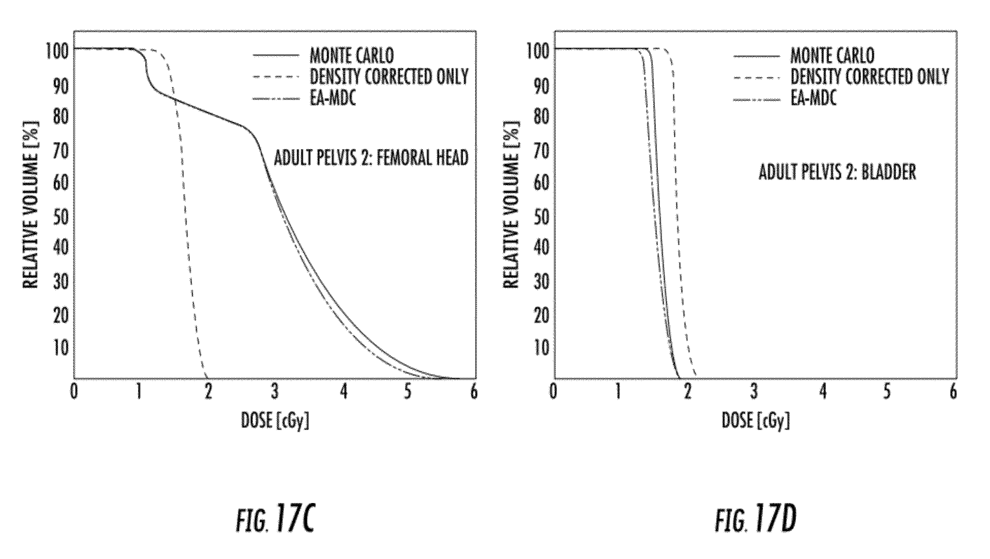

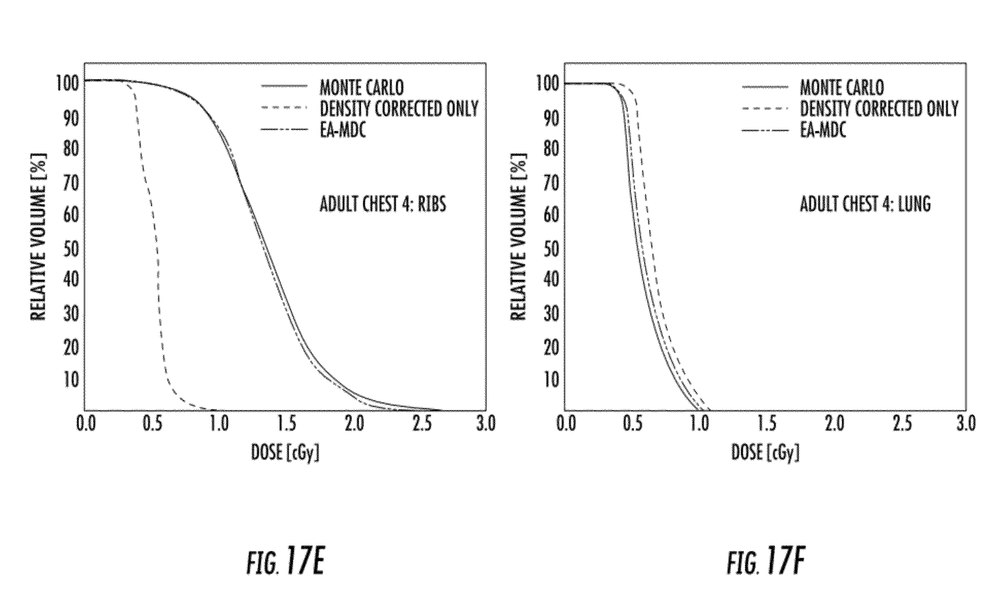

FIGS. 17A-17F shows dose-volume histograms (DVHs) for bone and soft-tissue structures for the Adult H&N 3 (FIGS. 17A and 17B), Adult Pelvis 2 (FIGS. 17C and 17D), and Adult Chest 4 patients (FIGS. 17E and 17F). Distributions for the spine, femoral head, ribs, parotid gland, bladder and lung are shown. The soft-tissue structures tend to have homogeneous dose distributions, whereas the dose distributions of bony structures are by comparison inhomogeneous. The density-corrected-only calculation results in significant underestimation of bone dose and overestimates the soft-tissue structure dose. The MDC-EA is capable of accurately accounting for the medium-dependent effect, reproducing the dose distributions to individual organs for each patient despite the disparate anatomies surrounding these structures, and is a significant improvement over the density-corrected-only calculations.

In some embodiments, adjustments to the MDC algorithm discussed herein can be provided to increase computational efficiency and speed by using a fluence/scatter method to calculate dose distribution instead of the convolution/superposition method described above. In this method the radiation dose to patients is calculated by calculating the dose to water-like media first. This can be done by assuming all voxels in a patient CT data set are water, but with densities scaled according to a CT-number-to-density calibration. The dose distribution to water-like media with physical density considered can be calculated by summation of pencil beam percent depth-dose curves, considering the incident x-ray fluence profiles and empirical x-ray scatter factors. The beam modeling parameters can be obtained in several ways, including by the Monte Carlo method. The final dose distribution calculated for the actual physical media can then be obtained using medium-dependent correction (MDC) factors. The MDC factor at a voxel can then expressed as a function of an intermediate quantity, the effective bone depth, which is calculated from patient CT data. This method is outlined in more detail below.

In these embodiments, the dose to water-equivalent media can be calculated by separately considering the contributions from primary photons and scattered photons:

[symbol]

. (9)

The dose from primary photons can be obtained by first calculating the primary photon fluence distribution in a CT-based volumetric phantom. This is done by discretizing the x-ray beam into a finite number of beams incident on the patient from a multitude of angles, and combining the primary fluence from each beam to obtain a total primary fluence distribution. The relative primary fluence for each incident beam can be expressed as

[symbol]

, (10)

where is the central-axis fluence profile as a function of depth, is the primary fluence profile along the anode-cathode direction, and is the primary fluence profile along the patient superior-inferior axis. These primary fluence profiles can be obtained at a given distance from the x-ray tube anode by using Monte Carlo methods. Density effects are accounted for in this method by using the radiological depth to obtain the central-axis fluence profile value. The radiological depth is given by:

[symbol]

, (11)

where is the radiological depth, is the density of the voxel a photon intersects, and is the distance that a photon travels in the i^{th} voxel. To obtain dose, the primary fluence distributions from each beam are combined and converted to dose using an empirical fluence-to-dose conversion factor,

[symbol]

. (12)

The dose from scattered photons is obtained by convolution of the primary photon fluence distribution with a scatter dose deposition kernel:

[symbol]

, (13)

where is an empirical scatter dose conversion factor, i indexes the incident, discretized x-ray beams, is the scatter dose deposition kernel, and the symbol denotes convolution. The scatter kernel was empirically obtained using Monte Carlo simulation and can be parameterized as:

[symbol]

, (14)

where is the vector from the interaction point to the calculation voxel, is the direction of the incident beam, and, A, B, and are empirical fitting parameters.

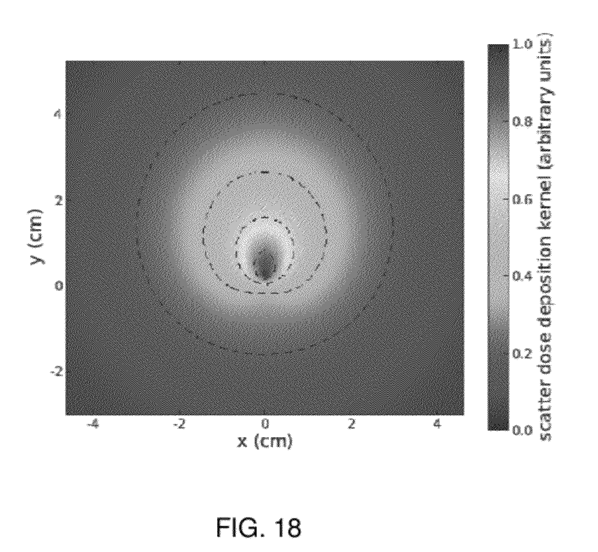

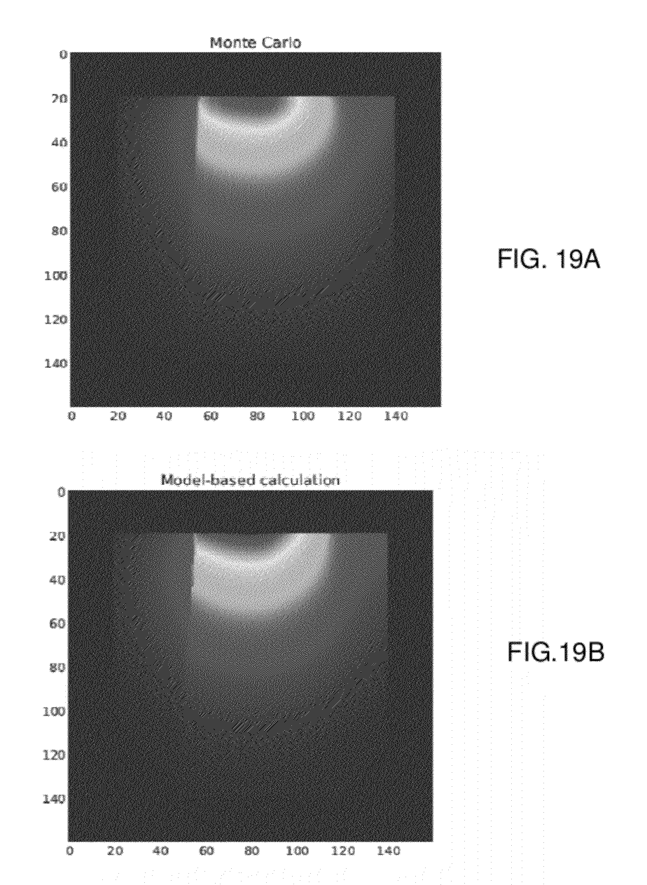

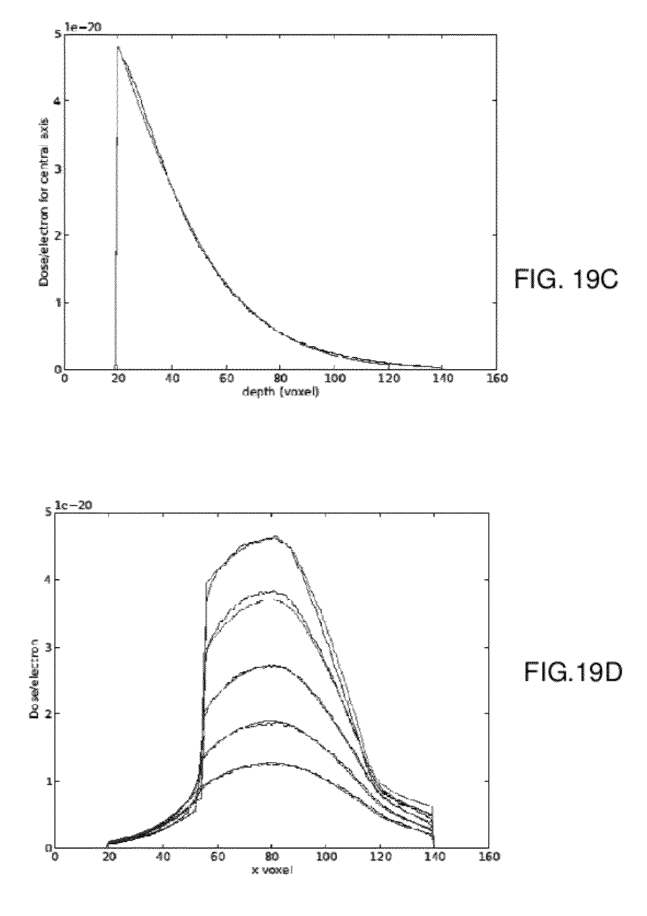

FIG. 18 shows the scatter dose deposition kernel used to calculate the dose to water-like media using the method described above. To illustrate the calculation accuracy of the new approach, we calculated the dose to a 30×30×30 cm³ water phantom from a single x-ray beam. The results of these calculations are shown in FIGS. 19A-19D.

FIGS. 19-19D show dose calculation results for a single x-ray beam incident on a 30×30×30 cm³ water phantom. The dose planes show the relative dose distributions calculated with Monte Carlo (FIG. 19A) and with the algorithm described above (FIG. 19B). The depth-dose curve (FIG. 19C) shows the Monte Carlo dose and the new model-based dose calculation along the central axis of the incident beam. The dose profiles (FIG. 19D) show the Monte Carlo dose and Model-based dose distribution parallel to the anonde-cathode axis of the x-ray tube at various depths within the phantom. As shown in FIGS. 19C and 19D, the results are substantially similar.

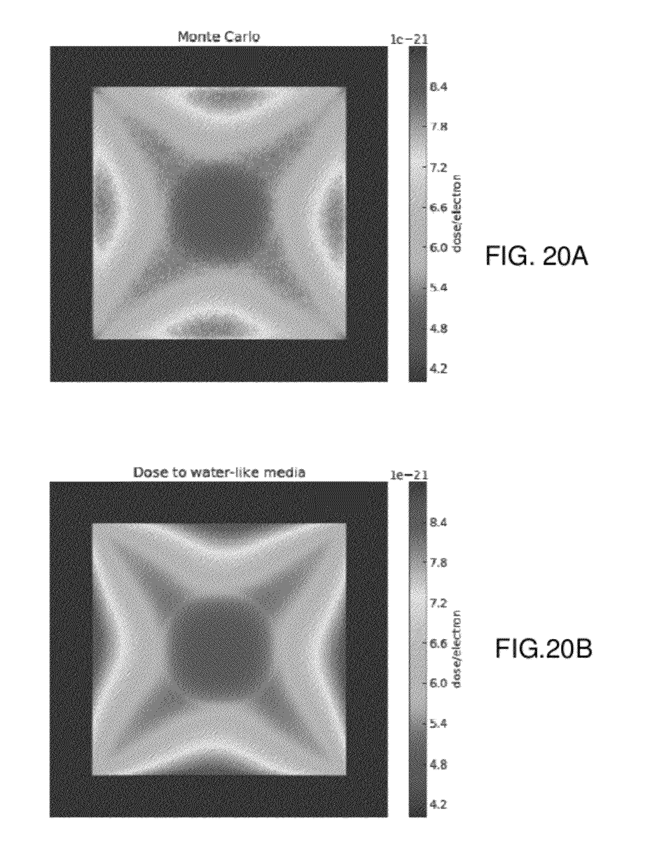

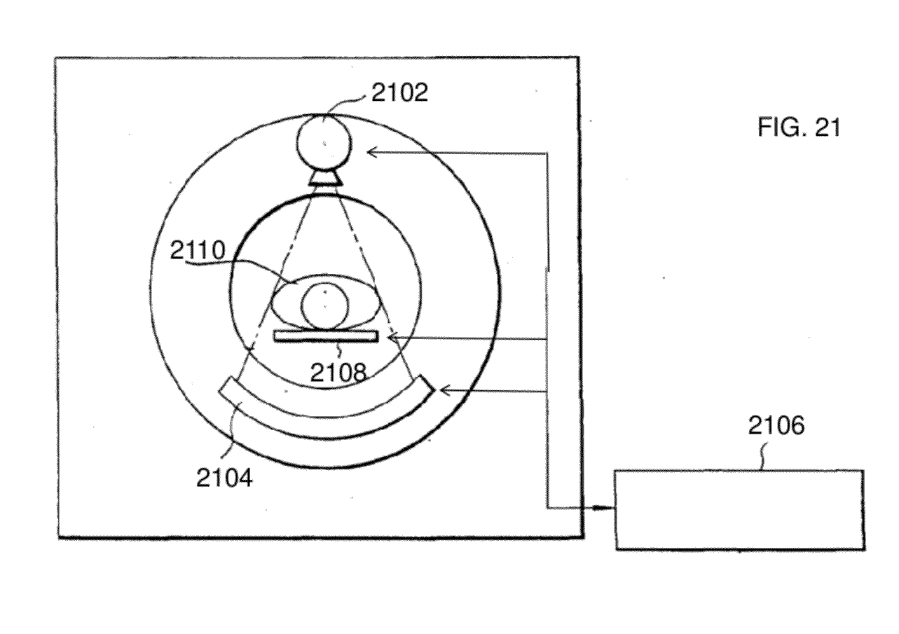

FIGS. 20A and 20B show example calculations of the dose to water-like media for a full kV-CBCT scan of a 30×30×30 cm³ water phantom. The distribution in FIG. 20A is the “gold-standard” Monte Carlo calculation, and the distribution in FIG. 20B is the calculation resulting from the method described above. In this calculation, the rotation of the x-ray beam was approximated by using 144 incident beams for which the fluence and scatter calculations were performed. Again, these results show that the results are substantially similar.

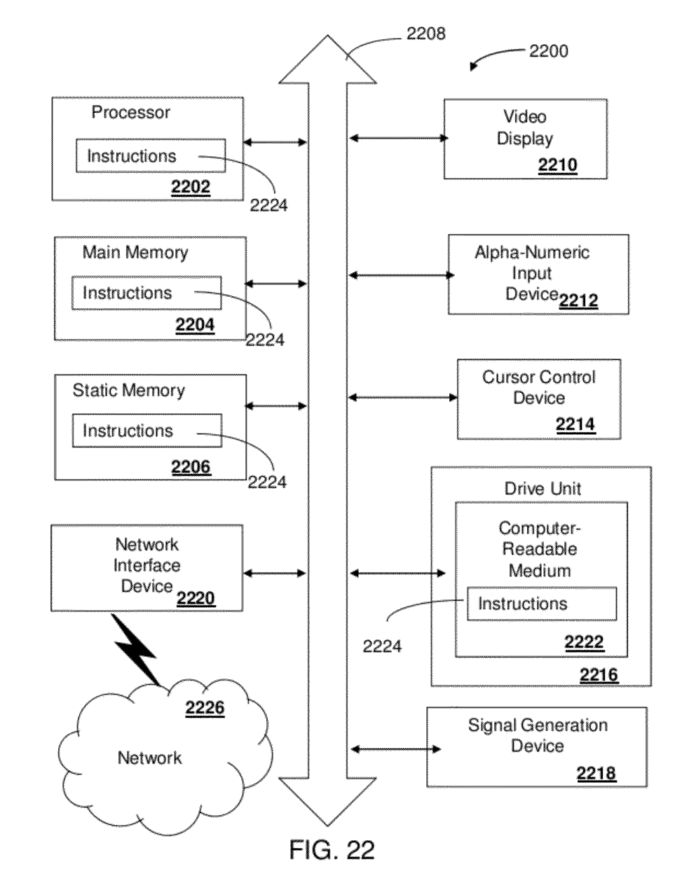

FIG. 21 is a schematic illustration of a system 2100 in which the various embodiments can be carried out. In particular, system 2100 includes a radiation emitter 2102, a radiation detector 2104, and a computer system 2106 for controlling the system 2100 and for computing radiation doses in accordance with the various embodiments. The system 2100 can also include a platform 2108 or other structure for supporting and positioning a patient 2110 and that is also controlled by computer system 2106. For example, as in a commercially available CT scan system.

In operation, the computing device can operate the emitter 2102 so that radiation passes through patient 2110 and reaches detector 2104. Optionally, the computer system 2106 can also adjust the platform 2108 to adjust the portion of the patient being exposed to radiation. The computer system 2106 can then process the signals from detector 2104 and generate and output signal, such as an image. The computer system 2106 can then also compute doses, as described above. However, the various embodiments are not limited to a CT scan system or any particular imaging or radiation treatment system. Rather, the various embodiments can be used with any type of system for exposing biological tissues to a radiation source. Further, the computing system 2106 can be located locally or remotely and can be implemented in a localized or distributed fashion, as described below.

FIG. 22 is a schematic diagram of a computer system 2200 for executing a set of instructions that, when executed, can cause the computer system to perform one or more of the methodologies and procedures described above. In some embodiments of the invention, the computer system 2200 operates as a standalone device. In other embodiments of the invention, the computer system 2200 can be connected (e.g., using a network) to other computing devices. In a networked deployment, the computer system 2200 can operate in the capacity of a server or a client developer machine in server-client developer network environment, or as a peer machine in a peer-to-peer (or distributed) network environment.

The machine can comprise various types of computing systems and devices, including a server computer, a client user computer, a personal computer (PC), a tablet PC, a laptop computer, a desktop computer, a control system, a network router, switch or bridge, or any other device capable of executing a set of instructions (sequential or otherwise) that specifies actions to be taken by that device. It is to be understood that a device of the present disclosure also includes any electronic device that provides voice, video or data communication. Further, while a single computer is illustrated, the phrase “computer system” shall be understood to include any collection of computing devices that individually or jointly execute a set (or multiple sets) of instructions to perform any one or more of the methodologies discussed herein.

The computer system 2200 can include a processor 2202 (such as a central processing unit (CPU), a graphics processing unit (GPU, or both), a main memory 2204 and a static memory 2206, which communicate with each other via a bus 2208. The computer system 2200 can further include a display unit 2210, such as a video display (e.g., a liquid crystal display or LCD), a flat panel, a solid state display, or a cathode ray tube (CRT)). The computer system 2200 can include an alphanumeric input device 2212 (e.g., a keyboard), a cursor control device 2214 (e.g., a mouse), a disk drive unit 2219, a signal generation device 2218 (e.g., a speaker or remote control) and a network interface device 2220.

The disk drive unit 2219 can include a computer-readable medium 2222 on which is stored one or more sets of instructions 2224 (e.g., software code) configured to implement one or more of the methodologies, procedures, or functions described herein. The instructions 2224 can also reside, completely or at least partially, within the main memory 2204, the static memory 2206, and/or within the processor 2202 during execution thereof by the computer system 2200. The main memory 2204 and the processor 2202 also can constitute machine-readable media.

Dedicated hardware implementations including, but not limited to, application-specific integrated circuits, programmable logic arrays, and other hardware devices can likewise be constructed to implement the methods described herein. Applications that can include the apparatus and systems of various embodiments of the invention broadly include a variety of electronic and computer systems. Some embodiments of the invention implement functions in two or more specific interconnected hardware modules or devices with related control and data signals communicated between and through the modules, or as portions of an application-specific integrated circuit. Thus, the exemplary system is applicable to software, firmware, and hardware implementations.

In accordance with various embodiments of the invention of the present disclosure, the methods described herein can be stored as software programs in a computer-readable medium and can be configured for running on a computer processor. Furthermore, software implementations can include, but are not limited to, distributed processing, component/object distributed processing, parallel processing, virtual machine processing, which can also be constructed to implement the methods described herein.

The present disclosure contemplates a computer-readable medium containing instructions 2224 or that receives and executes instructions 2224 from a propagated signal so that a device connected to a network environment 2226 can send or receive voice and/or video data, and that can communicate over the network 2226 using the instructions 2224. The instructions 2224 can further be transmitted or received over a network 2226 via the network interface device 2220.

While the computer-readable medium 2222 is shown in an exemplary embodiment to be a single storage medium, the term “computer-readable medium” should generally be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but not be limited to, solid-state memories such as a memory card or other package that houses one or more read-only (non-Volatile) memories, random access memories, or other re-writable (volatile) memories; magneto-optical or optical medium such as a disk or tape; and/or a digital file attachment to e-mail or other self-contained information archive or set of archives considered to be a distribution medium equivalent to a tangible storage medium. Accordingly, the disclosure is considered to include any one or more of a tangible computer-readable medium or apparatus or a tangible distribution medium or apparatus, as listed herein and to include recognized equivalents and successor media, in which the software implementations herein are stored.

Although the present specification describes components and functions implemented in the embodiments of the invention with reference to particular standards and protocols, the disclosure is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

Embodiments of the invention may be practiced without the theoretical aspects presented. Moreover, the theoretical aspects are presented with the understanding that Applicants do not seek to be bound by the theory presented.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The Abstract of the Disclosure is provided to allow the reader to quickly ascertain the nature of the technical disclosure. It is submitted with the understanding that it will not be used to interpret or limit the scope or meaning of the following claims.

What is claimed is:

1. A system comprising:
a storage element for storing data generated by a radiation detector configured for detecting radiation emitted from a radiation emitter; and
a processing element communicatively coupled to the storage element and configured for calculating an accurate dose of emitted radiation energy (D_{medium-dependent-corrected)} in biological tissues, the software comprising an algorithm for calculating:
D_{medium-dependent-corrected}(x,y,z)=D_{density-corrected}(x,y,z)f_{MDC}(x,y,z)
where D_{density-corrected} is the dose distribution calculated with a convolution/superposition method and f_{MDC} is a Medium-Dependent-Correction factor, where f_{MDC} is a function of effective bone depth d_{EB}(x, y, z) matrix expressed by the following equation:
f_{MDC}(x,y,z)≡f_{c}(d_{EB})
where f_{c} is a matrix of correction factor values for the system computed based on pre-defined correlation data between values for d_{EB}(x, y, z) and values for f_{c}.

2. The system of claim 1, wherein the emitted radiation having a wavelength from about 1000 to about 0.0001 nanometers, frequencies in a range from about 300 petahertz to about 300 exahertz (3×10¹⁷ Hz to 3×10²⁰ Hz) and emitted energies from about 0.001 kilo electron volt (keV) to about 999 keV.

3. The system of claim 1, wherein the emitted radiation, comprising a kilovoltage range from about 1 kV to about 500 kV.

4. The system of claim 1, wherein the emitted radiation, comprising a kilovoltage range from about 10 kV to about 200 kV.

5. The system of claim 1, wherein the effective bone depth matrix is calculated by computing an average of a bone thickness calculated for each beam incident on the biological tissues.

6. A method for accurately calculating radiation doses in biological tissues exposed to a radiation source, comprising:
computing a dose deposition kernel using convolution/superposition dose calculations based on a configuration of the radiation source;
obtaining a raw geometry of the biological tissues expressed in computed tomography (CT) numbers; and
determining the dose distribution (D_{medium-dependent-corrected}) in the biological tissues by calculating:
D_{medium-dependent-corrected}(x,y,z)=D_{density-corrected}(x,y,z)f_{MDC}(x,y,z)
where D_{density-corrected} is the dose distribution calculated with a convolution/superposition method and f_{MDC} is a Medium-Dependent-Correction factor, where f_{MDC} is a function of effective bone depth d_{EB}(x, y, z) matrix expressed by the following equation:
f_{MDC}(x,y,x)≡f_{c}(d_{EB})
where f_{c} is a matrix of correction factor values for the system computed based on pre-defined correlation data between values for d_{EB}(x, y, z) and values for f_{c}.

7. The method of claim 6, wherein the step of determining further comprises:
categorizing the CT numbers in the raw geometry to generate the medium geometry; and
calculating d_{EB}(x, y, z) by computing an average of a bone thickness calculated for each beam incident on the biological tissues based on the medium geometry.

8. The method of claim 6, wherein dose distribution expressed by D_{density-corrected}(x, y, z) comprises a dose to water.

9. The method of claim 6, wherein a radiation source emits radiation having a wavelength from about 1000 to about 0.0001 nanometers, frequencies in a range from about 300 petahertz to about 300 exahertz (3×10¹⁷ Hz to 3×10²⁰ Hz) and emitted energies from about 0.001 kilo electron volt (keV) to about 999 keV.

10. The method of claim 6, wherein the radiation source emits radiation in a kilovoltage range from about 1 keV to about 500 keV.

11. The method of claim 6, wherein the emitted radiation energies comprise a kilovoltage range from about 10 keV to about 200 keV.

12. A computer-readable medium having stored thereon executable instructions that, when executed by a processor, cause the processor to: compute a dose deposition kernel using convolution/superposition dose calculations based on a configuration of a radiation source; obtain a raw geometry of biological tissues exposed to the radiation source expressed in computed tomography (CT) numbers; and determining the dose distribution (D_{medium-dependent-corrected}) in the biological tissues by calculating:
D_{medium-dependent-corrected}(x,y,z)=D_{density-corrected}(x,y,z)f_{MDC}(x,y,z)
where D_{density-corrected} is the dose distribution calculated with a convolution/superposition method and f_{MDC} is a Medium-Dependent-Correction factor, where f_{MDC} is a function of effective bone depth matrix d_{EB}(x, y, z) expressed by the following equation:
f_{MDC}(x,y,z)≡f_{c}(d_{EB})
where f_{c} is a matrix of correction factor values for the system computed based on pre-defined correlation data between values for d_{EB}(x, y, z) and values for f_{c}.

13. A method for accurately calculating radiation doses in biological tissues exposed to a radiation source, comprising:
computing a dose deposition kernel using convolution/superposition dose calculations based on a configuration of the radiation source;
obtaining a raw geometry of the biological tissues expressed in computed tomography (CT) numbers; and
determining the dose distribution (D_{medium-dependent-corrected}) in the biological tissues by calculating:
D_{medium-dependent-corrected}(x,y,z)=D_{density-corrected}(x,y,z)f_{MDC}(x,y,z)
where D_{density-corrected} is the dose distribution calculated using on a dose to water-equivalent media approximation and f_{MDC} is a Medium-Dependent-Correction factor, where f_{MDC} is a function of effective bone depth d_{EB}(x, y, z) matrix expressed by the following equation:
f_{MDC}(x,y,z)≡f_{c}(d_{EB})
where f_{c} is a matrix of correction factor values for the system computed based on pre-defined correlation data between values for d_{EB}(x, y, z) and values for f_{c}.

14. The method of claim 13, wherein the dose to water-equivalent media approximation is calculated based on the contributions of primary photons and scattered photons.

15. The method of claim 14, wherein the contributions of the primary photons are obtained by combining primary fluence distributions from each beam incident on the biological tissues and converting the a primary dose using a fluence-to-dose conversion factor.

16. The method of claim 15, wherein the fluence-to-dose conversion factor is an empirical fluence-to-dose conversion factor.

17. The method of claim 14, wherein the contributions of the scatter photons are obtained by convolution of primary fluence distributions from each beam incident on the biological tissues with a scatter dose deposition kernel.

18. The method of claim 17, wherein the scatter dose deposition kernel is an empirical scatter dose deposition kernel.

19. A system comprising:
a storage element for storing data generated by a radiation detector configured for detecting radiation emitted from a radiation emitter; and
a processing element communicatively coupled to the storage element and configured for calculating an accurate dose of emitted radiation energy (D_{medium-dependent-corrected)} in biological tissues, the software comprising an algorithm for calculating:
D_{medium-dependent-corrected}(x,y,z)=D_{density-corrected}(x,y,z)f_{MDC}(x,y,z)
wherein D_{density-corrected} is the dose distribution calculated using on a dose to water-equivalent media approximation and f_{MDC} is a Medium-Dependent-Correction factor, where f_{MDC} is a function of effective bone depth d_{EB}(x, y, z) matrix expressed by the following equation:
f_{MDC}(x,y,z)≡f_{c}(d_{EB})
where f_{c} is a matrix of correction factor values for the system computed based on pre-defined correlation data between values for d_{EB}(x, y, z) and values for f_{c}.

20. The system of claim 19, wherein the processor is further configured for calculating the dose to water-equivalent media approximation based on the contributions of primary photons and scattered photons.

21. The method of claim 20, wherein the contributions of the primary photons are obtained by combining primary fluence distributions from each beam incident on the biological tissues and converting the a primary dose using a fluence-to-dose conversion factor.

22. The method of claim 21, wherein the fluence-to-dose conversion factor is an empirical fluence-to-dose conversion factor.

23. The method of claim 20, wherein the contributions of the scatter photons are obtained by convolution of primary fluence distributions from each beam incident on the biological tissues with a scatter dose deposition kernel.

24. The method of claim 23, wherein the scatter dose deposition kernel is an empirical scatter dose deposition kernel.
